(19) United States
(12) Patent Application Publication
(10) Pub. No.: US 2009/0234876 A1
(43) Pub. Date: Sep. 17, 2009

(54) SYSTEMS AND METHODS FOR CONTENT SHARING

(76) Inventors: Timothy Schigel, Cincinnati, OH (US); David E. Goldberg, Champaign, IL (US)

Correspondence Address: JONES DAY, 222 EAST 41ST ST, NEW YORK, NY, 10017, US

(21) Appl. No.: 12/048,789

(22) Filed: Mar. 14, 2008

(51) Int. Cl. G06F 15/16; G06F 17/30

(52) U.S. Cl. 707/102; 709/203; 707/100; 707/E17.032

(57) ABSTRACT

Systems and methods to enhance relevancy efficiency of content sharing within a meta-community through content recommendation and recipient recommendation is provided. The systems and methods analyze sharing activities within the meta-community, both of members and of un-registered users through member sharing interactions, to create sharing preference profiles for members and un-registered users. The present invention also provides systems and methods for storing shared content and for monitoring web activities. The sharing preference profiles are used to provide content recommendations in which relevant content is selected from among content previously shared in the meta-community or content predicted as highly relevant to the sharing preference profiles of meta-community members. The sharing preference profiles are also used to provide recipient recommendations based on similarities of sharing preference profiles between members or un-registered users who are socially connected to each other, such as through their electronic address books.

### 1. FIELD OF THE INVENTION

The present invention relates generally to methods and systems for sharing content via network platform(s). More specifically, systems and methods are disclosed for improving information sharing among members of a meta-community through a host application on a networked client device. The relevance of information shared is improved based on sharing preference profiles of the members of the meta-community who may be selected as recipients of the content to be shared. The systems and methods provide a remote data server that stores and processes sharing preference profiles. Systems and methods are disclosed for analyzing content sent and received by members of a meta-community in order to create the sharing preference profiles.

### 2. BACKGROUND OF THE INVENTION

Fundamentally, the ultimate purpose of any network (e.g., an Ethernet, a wireless network, or a telephone network) is to allow effective communication among the users of the network. Often such communication occurs through the exchange or sharing of information. For example, the prototypical “killer network application,” Internet-based “e-mail,” allows communications between any two parties so long as they have access to the common network. A central aspect of any communication is information sharing. People have used e-mails to share with their friends and colleagues their thoughts, memories, photographs, videos, interesting articles of websites they have found, and more. The Internet-based e-mail communication method facilitates sharing of information of almost any format, including text, graph, audio, flash, video, as well as executable files.

Despite its versatility, however, e-mail-based sharing has been ad hoc and directed primarily by the sharer, defined herein as the person who sends the information, rather than the sharee, defined herein as the person who receives the information. This is because of the lack of any formal mechanism for the sharees to “pull” data, or to make their preference known to the sharers prior to the sharing processes take place. Instead, this type of sharing method relies on the personal relationships between the sharers and sharees to ensure that relevant information gets shared. This environment of sharing stands in contrast with Internet searches where a receiver of the search results (i.e., the searcher) essentially has control over the outcome of the searches. When a searcher desires a particular type of information, the searcher simply enters one or more “key words” into a search engine, which then returns a comprehensive list of possibly related information that correlates with the key words. The searcher then attempts to identify the information from the comprehensive list. While functional, search engines are unsatisfactory in many ways. For instance, it is difficult for a search engine to determine the true relevance of any particular page to a searcher given the low information content of a handful of key words. In addition, web site operators are engaged in a continuing battle with search engine operators in an attempt to game the system and have their web sites artificially ranked higher (more relevant) in the results than are merited. Finally, the current business model for most search engine operators involves placing advertisements on each result page, thus actually creating an incentive for them to force searchers to spend more time and effort looking for the most relevant results, and thus seeing more advertisements. It is important to recognize that the relevance of a given piece of content to a particular user consists of at least two factors: the topical relevance to the user and the quality of the information. Although semantic engines can reasonably well-establish the former, for example, by looking at keywords, the latter has proven extremely difficult to automatically determine.

Conventional systems and methods for sharing information are rather cumbersome and inconvenient, especially when sharers (senders of any shared content) and sharees (receivers of the shared content) belong to different network groups (e.g., web-based e-mail users and cellular phone users). FIG. 1A outlines the steps that are taken in a conventional network in order to share information. A network user first needs to identify the content to be shared (e.g., step 1). The user is then required to highlight and copy an identifier that represents the content to be shared (e.g., a URL or link of step 2 of FIG. 1A). The user then launches an e-mail service provider such as gmail, Yahoo! Mail or hotmail (e.g., step 3 of FIG. 1A). The user initiates a new mail message and pastes the identifier into either the body or subject line of the message (e.g., step 4 of FIG. 1A). The user may further proceed to type a message that will accompany the content to be shared (e.g., step 5 of FIG. 1A). The user is also required to enter a network identifier such as an email address to specify the recipient of the content (e.g., step 6 of FIG. 1A). Finally the user may send the content to the designated recipient (e.g., step 7 of FIG. 1A). As shown, the process involves several steps just to share data with a single sharee. Moreover, the relevance of the content to be shared relies on close personal knowledge between the sharers and sharees. In addition, diverse systems and methods for communication (and hence sharing) bring more complications into the system.

Given the above background, what is needed in the art is easier and more efficient systems and methods for improving topic relevance for the recipient and the quality of the information being shared.

### 3. SUMMARY OF THE INVENTION

This present invention provides improved systems and methods for sharing information by relying on the ability of humans to assess the quality of the content, while allowing for the automation of the assessment of topical relevance to promote simple and efficient sharing across various network platforms. The present invention provides systems and methods to enhance relevancy efficiency of content sharing within a meta-community through content recommendations and recipient recommendations. The systems and methods analyze sharing activities within the meta-community, both of members as well as of un-registered users (through their sharing interactions with the members), to create sharing preference profiles for members and un-registered users. The present invention also provides systems and methods for storing shared content and for monitoring web activities. The sharing preference profiles are then used to provide content recommendation, e.g., relevant content selected among content previously shared in the meta-community or content predicted as highly relevant to the sharing preference profiles. The sharing preference profiles are also used to provide recipient recommendations based on similarities of sharing preference profiles between members or un-registered users who are socially connected such as through an electronic address book.

In a meta-community, one or more groups of users (e.g., members) are virtually “linked” to each other, for example, by taking advantage of systems knowledgeable about the types of content each member of the meta-community prefers to receive or send. In some embodiments, a meta-community as disclosed here is an ad hoc community, unlike a “fixed” community. For example, when a new user registers through a client device at remote data server 20, one or more files and/or data structures specific to the user are created on the remote data server for the user and the user becomes a member of a meta-community. In some embodiments, the files and/or data structures comprise a contact list and a sharing preference profile associated with the member. Advantageously, the contact list can be based on one or more electronic address books associated with the member (e.g., gmail address book, Yahoo! address book) and/or built or edited manually by the user. Upon registration of this new user, the meta-community has been expanded to include one or more network identifiers of the new user (e.g., email address, phone number, personalized URLs, unique IP address) and network identifiers included in the contact list of this user. In some embodiments, a meta-community comprises the network identifiers in all contact lists of all registered members. The meta-community is dynamic. It constantly changes as more users register at the remote data server (e.g., become members) or as a member chooses to share content with more network identifiers that are not originally included in the member's contact list. As such, the meta-community includes not only registered members but also un-registered users of the meta-community.

The present invention provides systems and methods for sharing content within a meta-community based on previously shared content. Each member of the meta-community has stored on a remote data server (i) one or more network identifiers, (ii) a sharing preference profile, and (iii) a contact list comprising a plurality of network identifiers. Each network identifier in the plurality of network identifiers identifies a member in a plurality of members in the meta-community. The meta-community comprises registered members and un-registered users from the contact lists of all members and is constructed by incorporating information from one or more electronic address books of each member in the meta-community. Both types of recommendation are determined based on the sharing preference profiles (each of which is determined at least partially based on previous shared content associated with the respective member or un-registered user).

In some embodiments, content-sharing of the present invention comprises: receiving, from a first member of the meta-community, an identification of first content to be shared through a host application on a client device through which the host application is connected to a network. Then, from a sharing interface via the host application, responsive to the sharing step, a plurality of suggested recipients within a contact list of the first member that are identified are proposed, without user intervention, based on a comparison of (1) the sharing preference profiles of members of the meta-community and (2) at lease one characteristic of the first content. Next, there is accepted, from the first member, a selection of one or more actual recipients from the plurality of suggested recipients. The first identification or the content associated with the first identification is transmitted via a network to one or more actual recipients via the sharing interface. The plurality of suggested recipients comprises a plurality of network identifiers associated with the plurality of suggested recipients. The plurality of suggested recipients is determined using a database addressable by the remote data server that stores the sharing preference profiles of members of the meta-community.

In some embodiments, a sharing preference profile of a respective member in the meta-community is created based on a list of interests provided by the respective member. In some embodiments, the plurality of suggested recipients that is proposed is identified by one or more network identifiers associated with the plurality of suggested recipients. In some embodiments, the sharing interface comprises means for inputting a network identifier of the first member and means for associating the contact information with the first content.

In some embodiments, each suggested recipient in the plurality of proposed recipients is identified by an email address, a telephone number, a messenger identification, a unique uniform resource location, or an online alias. In some embodiments, the contact list for the first member is automatically obtained from an electronic address book associated with the first member without user intervention from first member at a time before the receiving step.

In some embodiments, the electronic address book is an online email address book, an online chat address book, an online messenger address book, an email program address book, or an operating system address book. In some embodiments, the content is a text message, a uniform resource location, a web link, an electronic message, a file, an image, an audio file, a video file, or a media file. In some embodiments, the client device is selected from the group consisting of a desktop computer, a laptop computer, a cellular phone, a personal digital assistant (PDA), a mobile device equipped with a network device, a pager, a television, a media player, a digital video recorder (DVR), and a networked device.

The present invention also provides a computer system that comprises a processor, and a memory coupled to the processor. The computer encodes one or more programs which cause the processor to carry out the method of any one of the methods described herein.

The present invention further provides a computer program product for use in conjunction with a computer having a processor and a memory connected to the processor. The computer program product comprises a computer readable storage medium on which a computer program mechanism is encoded. The computer program mechanism may be loaded into the memory of the computer and cause the computer to carry out the method of any one of the methods described herein.

### 4. BRIEF DESCRIPTION OF THE DRAWINGS

FIG. 1A illustrates an exemplary sharing process in accordance with the prior art.

FIG. 1B illustrates an exemplary embodiment of a sharing system in accordance with the present invention.

FIG. 2A illustrates an exemplary sharing process between exemplary client device systems in accordance with the present invention.

FIG. 2B illustrates an exemplary sharing process between an exemplary client device system and an exemplary remote data server in accordance with the present invention.

FIG. 2C illustrates an exemplary sharing interface in accordance with the present invention.

FIG. 2D illustrates an exemplary sharing interface in accordance with the present invention.

FIG. 2E illustrates an exemplary sharing interface in accordance with the present invention.

FIG. 3 illustrates an exemplary remote data server in accordance with the present invention.

FIG. 4A illustrates an exemplary embodiment of a membership registration process in accordance with the present invention.

FIG. 4B illustrates an exemplary embodiment of a process for determining a sharing preference profile in accordance with the present invention.

FIGS. 4C and 4D illustrate an exemplary embodiment of a sharing process in accordance with the present invention.

### 5. DETAILED DESCRIPTION OF THE INVENTION

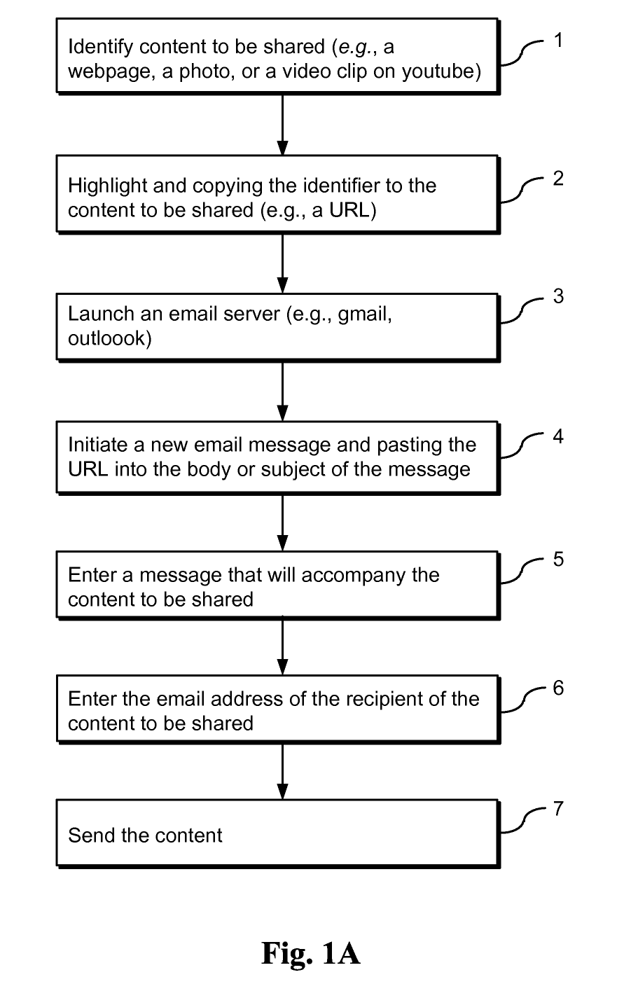

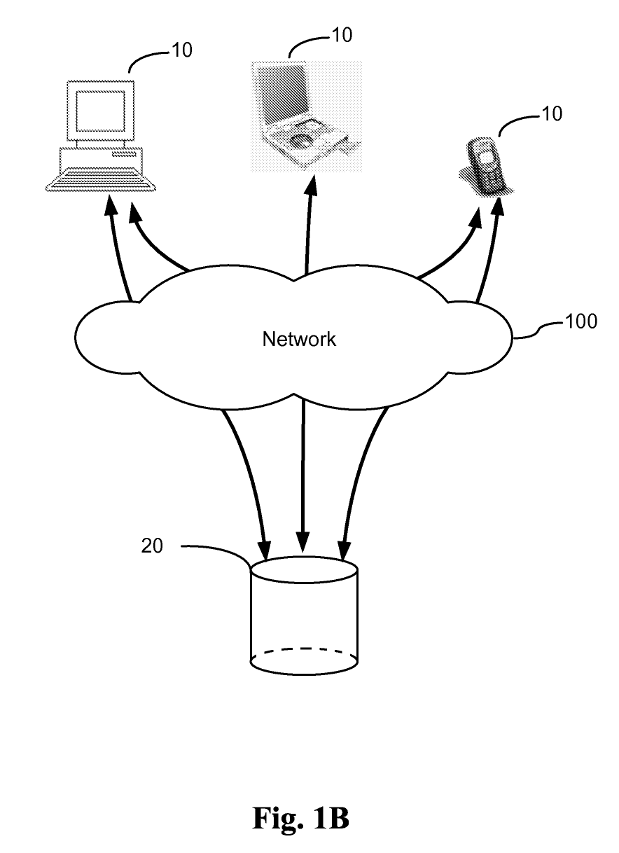

Illustrated in FIG. 1B are the elements of a typical system in which the present invention may function that includes one or more client devices 10, a network 100, and one or more remote data servers 20. It will be appreciated by one of skill in the art that data that is designated for storage on a remote data server 20 may in fact be stored on any one of several remote data servers 20 or across several remote data servers 20 (meaning that portions of the data a stored on different remote data servers 20). For convenience, such remote data servers 20 will be referenced herein in the singular even in instances where any combination of several remote servers 20 could be used. The present invention provides systems and methods for users to share relevant information by taking advantage of a meta-community through which a group of users (e.g., members) are virtually “linked” to each other, and by taking advantage of systems knowledgeable about the types of content each member of the meta-community prefers to receive or send. In some embodiments, a meta-community as disclosed here is an ad hoc community, unlike a “fixed” community. For example, when a new user registers through a client device at remote data server 20, one or more files and/or data structures specific to the user are created on the remote data server for the user and the user becomes a member of a meta-community. In some embodiments, the files and/or data structures comprise a contact list and a sharing preference profile associated with the member. Advantageously, the contact list can be based on one or more electronic address books associated with the member (e.g., gmail address book, Yahoo! address book) and/or built or edited manually by the user. Upon registration of this new user, the meta-community has been expanded to include one or more network identifiers of the new user (e.g., email address, phone number, personalized URLs, unique IP address) and network identifiers included in the contact list of this user. In some embodiments, a meta-community comprises the network identifiers in all contact lists of all registered members. The meta-community is dynamic. It constantly changes as more users register at the remote data server (e.g., become members) or as a member chooses to share content with more network identifiers that are not originally included in the member's contact list. As such, the meta-community includes not only registered members but also un-registered users of the meta-community. An un-registered user is a user who has not registered at the remote data server and accordingly has not submitted a contact list. An un-registered user can still have a sharing preference profile stored on the remote data server, but the sharing preference profile is only based on content received by the un-registered user from a member. In some embodiments, a registered member may also elect not to submit a contact list. Instead, the contact list will be updated or modified as the member shares or receives content with other registered members or unregistered users. In some embodiments, the meta-community also comprises users that are on contact lists of registered members, but have not received any information from the members. These users are dormant users of the meta-community, no sharing preference profiles are created for them until sharing activities take place between them and the registered members. More details about sharing preference profiles are found in Section 5.5.2.

The meta-community disclosed herein is advantageous over existing social networks in several aspects. It does not require a user to register for a particular community on a social network. Instead, the meta-community takes advantage of the embedded networks in existing services (e.g., email address book, a Facebook address book, a Myspace address book, etc.) of each user that desires to share content via the systems and methods of the present invention. Usually, in one of the address books, a contact person is identified by one or more network identifiers such as an email address, a chat ID, an instant messaging ID, a phone number, or a fax number. The meta-community expands as more users participate to share content via the systems and methods of the present invention, but does not in fact require the users to register for a particular network community. The meta-community disclosed herein is also advantageous over website-based social network such as Facebook™ or MySpace™ in that the meta-community does not need a website. A meta-community is a siteless social network for sharing information without the complication of having to join and maintain social network groups. Instead, information shared in the meta-community or between a meta-community member and an unregistered user is used as reference to guide such sharing activities. In essence, the meta-community encompasses all network information related to all the users who participate in the sharing as disclosed in the present invention.

### 5.1. Overview of a Sharing System

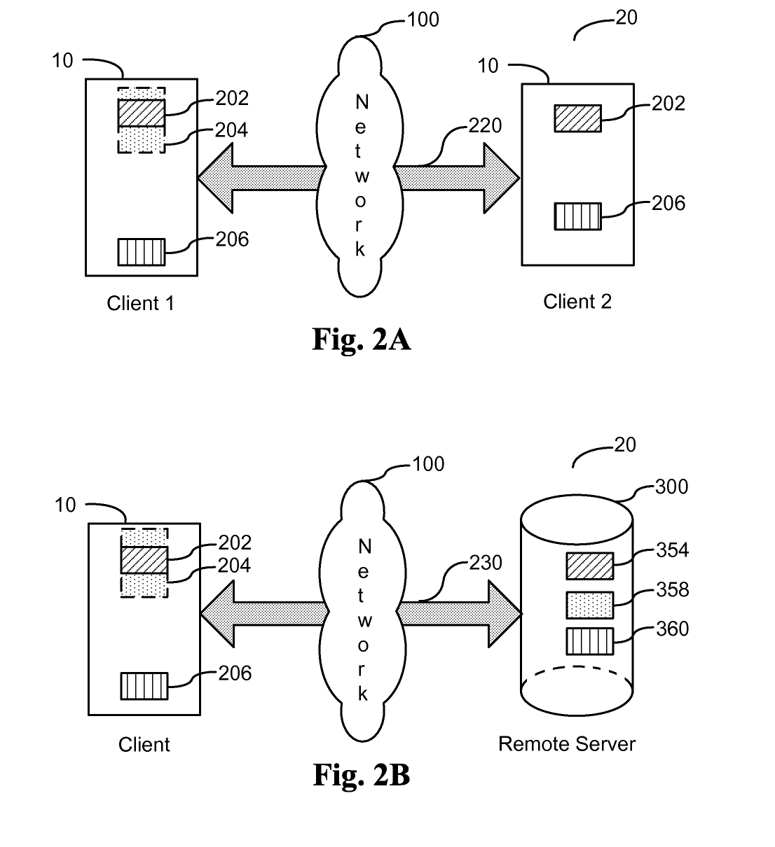

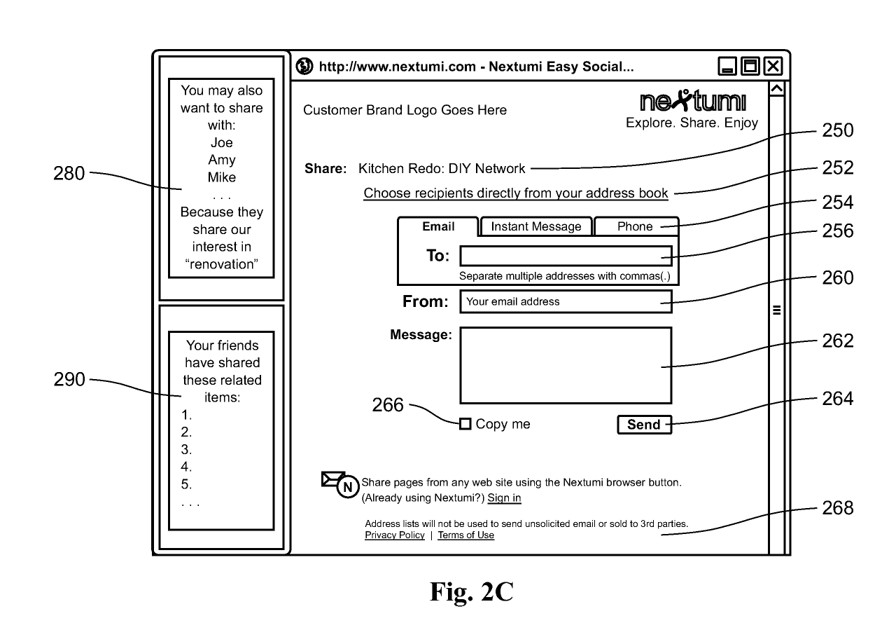

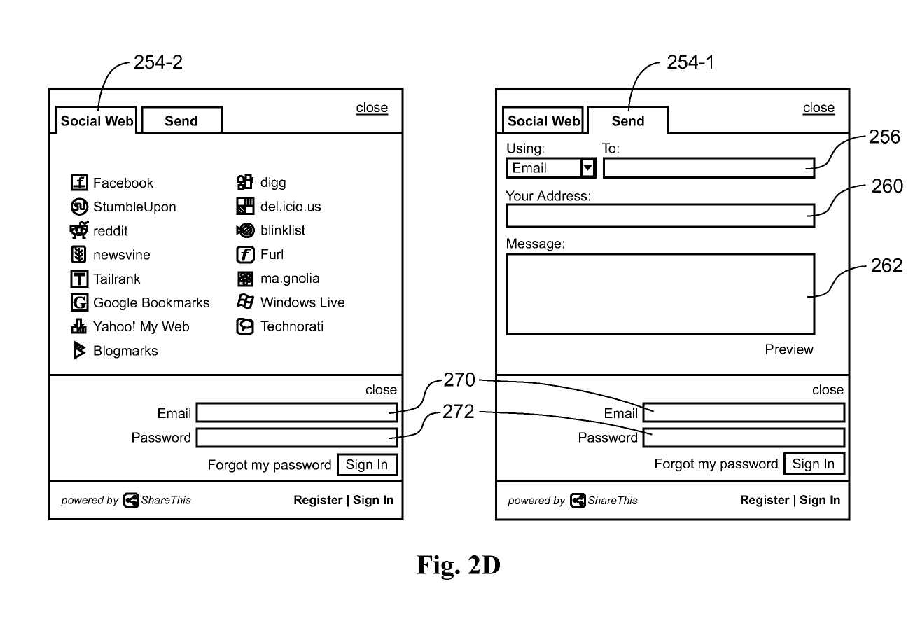

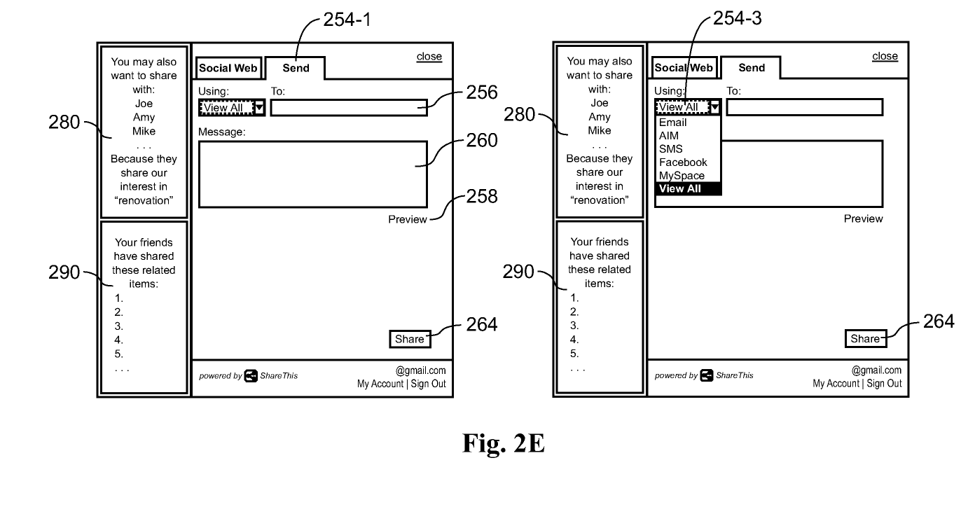

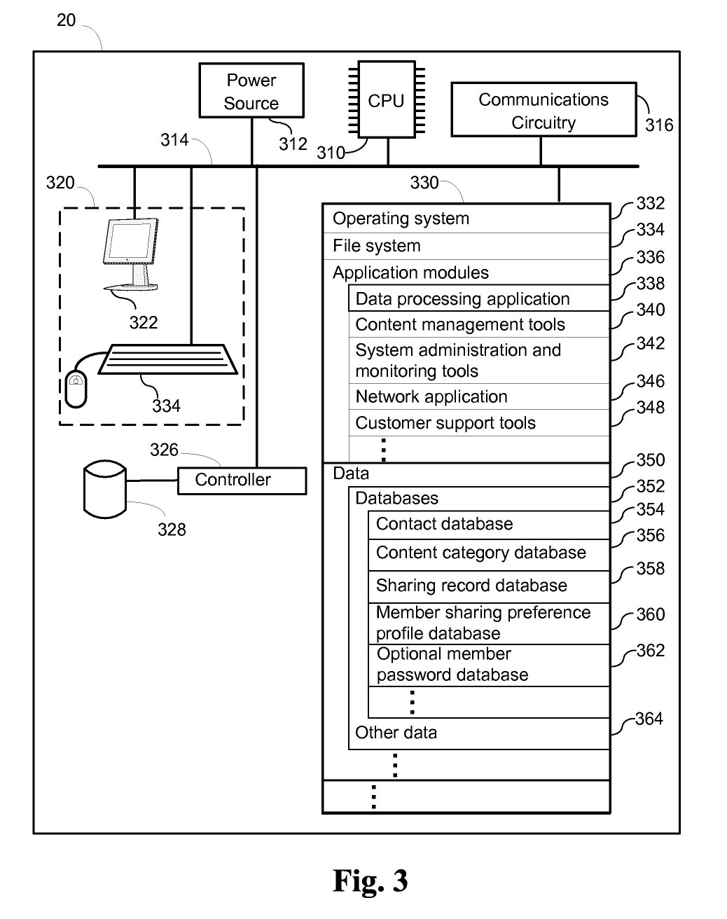

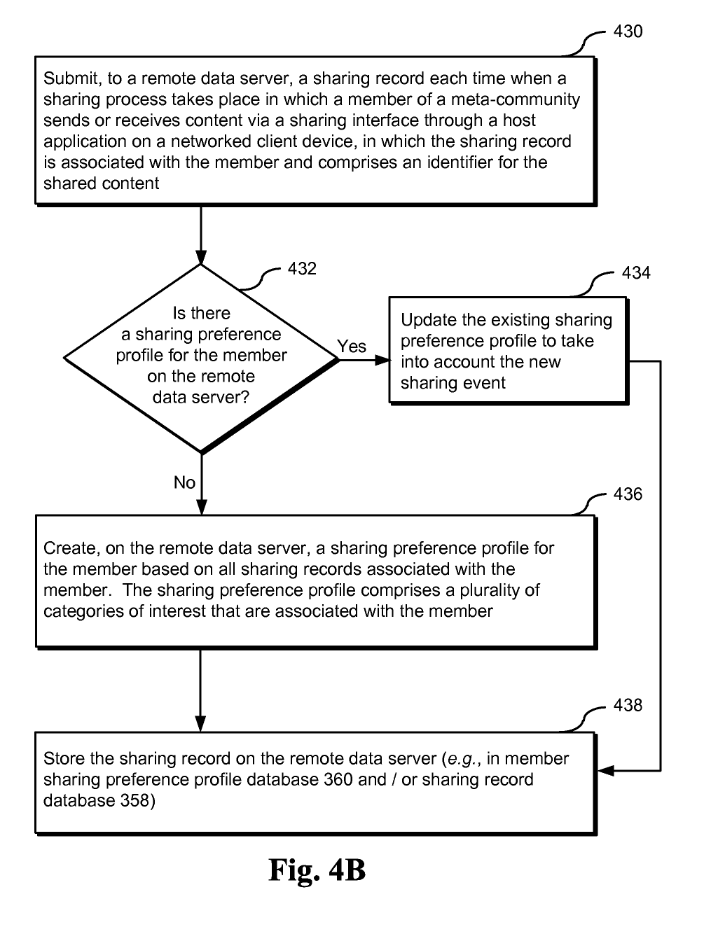

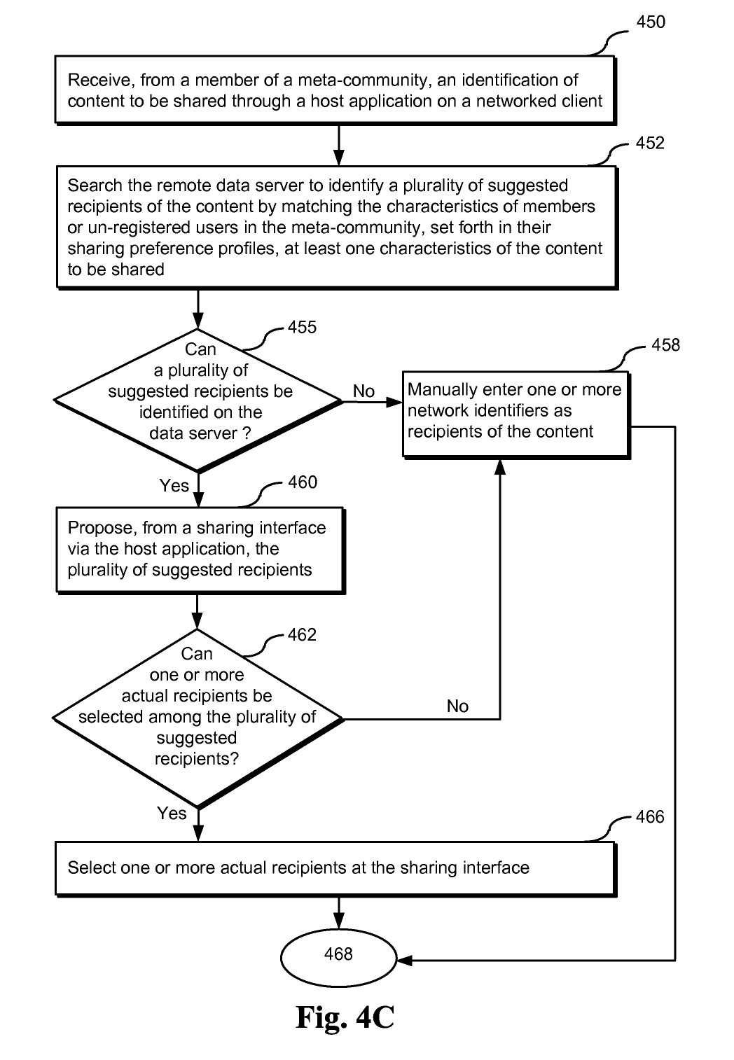

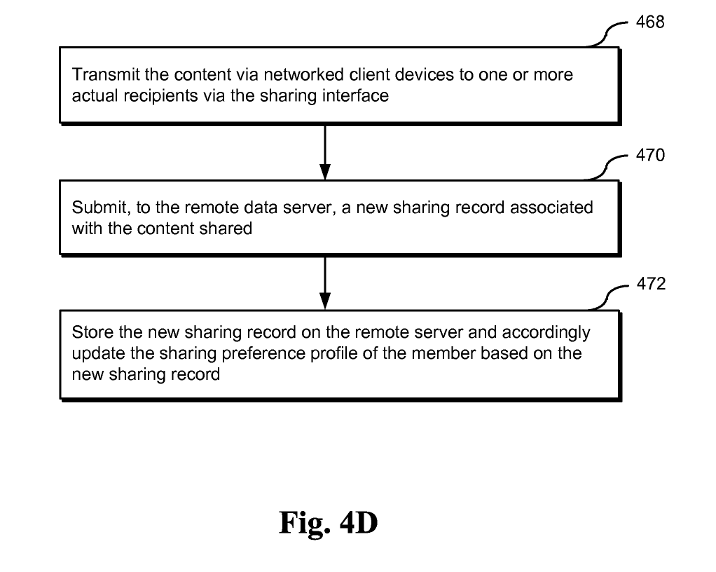

In some embodiments, multiple members belong to a network-based meta-community and are connected with each other through one or more network (e.g., 100) through host applications on their respective client devices (e.g., 10 in FIGS. 1B, 2A and 2B). An exemplary system comprises a remote data server system (e.g., 20) that is also equipped with network capacity. More importantly, a system in accordance with the present invention is capable of and more preferably has learned about the interests of each member of the network-based meta-community. In some embodiments, the remote data server performs the learning process and provides suggestions of one or more recipients when a member requests to share certain information through the system. The interests of members of the network-based meta-community are stored in sharing preference profiles on the remote data server 20. Furthermore, each time content is shared between members through their respective client devices, a sharing record is communicated to remote data server 20 and analyzed to create or update sharing preference profile for the members. Content is shared between members of the meta-community through network 100. Information regarding the content sharing between members is also transmitted to remote data server 20 through the network. In some embodiments, a registration process is necessary to establish membership to the network meta-community, for example, as depicted in FIGS. 2C and 4A. However, it is not necessary that a user with a network identifier to register in order to share content with members of the meta-community. In some embodiments, a user may be included in the contact book of a registered member. In other embodiments, a user member may receive information from a registered user. In all these cases, those individuals are known to the system disclosed herein and may be “members” of the meta-community, albeit with different status values. In some embodiments, a non-member may be represented anonymously by virtue of a cookie or other means. In some embodiments, the sharing preference profile of a member is updated after the member elects to send content in accordance with the present invention. In some embodiments, the sharing preference profile is created based on information provided by the member concerning the members' sharing interests. In some embodiments, the sharing preference profile of a member is updated after the member elects to receive content in accordance with the present invention. A detailed description of exemplary host applications is disclosed in Section 5.2. A detailed description of exemplary client devices is disclosed in Section 5.3. A detailed description of exemplary remote data server is disclosed in Section 5.4. A detailed description of exemplary network meta-community and the registration thereto is provided in Section 5.5. Additional exemplary methods and systems suitable for implementing the current invention are disclosed in Section 5.6.

### 5.2. Host Application and Sharing Interface

A sharing process in accordance with the present invention is implemented at the user end by at least one host application that provides a sharing interface on at least one client device.

5.2.1. Host Applications

In embodiments in accordance with the present invention, a member can request content sharing by launching a sharing interface through a host application after the member has identified the content to be shared. In one aspect of the invention, a host application (e.g., 202 of FIG. 2A, either as an embedded application in another program or as a stand-alone program) facilitates information exchange between client devices (e.g., 10 in FIGS. 1B, 2A and 2B), in particular to allow easy sharing of content between users who have access to these client devices. In another aspect of the invention, host application 202 also facilitates information exchange between a client device 10 and a remote data server 20, as depicted in FIG. 2B. Information that is shared between client devices 10 may include one or more identifiers that can represent files of any format. In preferred embodiments, the files, e.g., the content to be shared between client devices, is not transferred between client devices 10. Instead, one or more identifiers of content or members (e.g., a web URL depicted as 220 or 230 in FIG. 2A or 2B) are transferred between the client devices. Information that is shared between a client device 10 and remote data server 20 may also include one or more identifiers that represent files of any format. In preferred embodiments, an identifier (e.g., a web URL) representing the content being transferred is communicated to remote data server 20 as part of a sharing record.

5.2.1.1. Host Applications Embedded within a Network Browser

A network browser, often a web browser, is a software application that enables a user to display and interact with text, images, videos, music and other information typically located on a Web page at a website on the World Wide Web or a local area network. For example, as depicted in FIG. 2A, client device 10 comprises a host application 202 that is embedded in a network browser 204 while client device 10 comprises a host application 202 that is a stand-alone application as shown in FIG. 2B. In some embodiments, host application 202 may be an Application Programming Interface (API) or an Application Binary Interface (ABI) application embedded in a network browser 204, for example, Internet Explorer, Mozilla Firefox, Safari, Opera, Opera Mini, Camino, Netscape, or Lynx. Under these situations, the host application functions as a plug in application that interacts with the host application (e.g., a network browser or an email client) to provide a certain, usually very specific, function “on demand,” for example, allows members to easily exchange content through a network. The present invention is applicable to network browsers on any system platforms, including Macintosh (e.g., OS X systems including Cheetah and Puma, Jaguar, Panther, Tiger, and Leopard), Windows (including but is not limited to Windows NT, XP, and Vista), Linux, or Unix.

In some embodiments, the network browser can be used on any networked client device, including but not limited to, for example, a desktop computer, a laptop computer, a cellular phone, a personal digital assistant (PDA), an iPod, a television, a media player, an DVR, a mobile device equipped with a network device. When the host application is embedded in a network browser, it may exist as a toolbar, similar to Google toolbar or Yahoo! Toolbar. In other embodiments, the host application may exist as a share button on a page of a network browser (e.g., Internet Explorer, Firefox, Safari, Opera, Netscape, or Mozilla), and a member may elect to sign in or log out of the host application by using the button. In still other embodiments, the host application exists as an embedded share button or link on a web page, within a media player, or in an object such as a flash file. In some embodiments, the host application is initiated at the same time when a member identifies information to be shared. In some embodiments, the information to be shared is identified as a part or all of the content of a web page. After a member identifies the information to be shared, the member may launch the host application by clicking on the toolbar or the share button. In some embodiments, a sharing interface appears after the member launches the host application. In these embodiments, a member needs to install the host application onto a network client device as either a toolbar or a share button.

In some embodiments, the host application is more closely associated with the content that will be shared between the members. The host application may be embedded in a web page, for example, as a share button after a web publication such as an article, a photo, a video, etc. A sharing interface may be launched by clicking the share button associated with the content a member wishes to share. In these embodiments, the host application functions similarly to a publisher's button, which requires partnership with web publishers and hosts of various web sites. These embodiments are advantageous in they do not require a member to install the host application, which renders the sharing systems and methods more versatile and portable.

This method described here is well suited for a standard network browser running on a desktop or laptop computer. However, network browsers or similar programs designed for other networked devices are readily available. Accordingly, embodiments described in this section may be applicable to any network mobile device, including cellular phones, personal digital assistants (PDA), networked iPods or other mp3 players, or network enabled digital or video cameras.

5.2.1.2. Host Applications as a Stand-Alone Program

In some embodiments, a host application may be a stand-alone program on a client device, for example, as a specialized sharing program on a cell phone device or as a part of a software program bundle (e.g., Blackberry-based software package; standard software packages for cellular phone or pocket PC or other handheld devices made by Microsoft Corp., Research In Motion Ltd., Palm Inc., or Symbian; or Google's mobile software package).

In some embodiments, the stand-alone sharing program on a client device 10 may be implemented through existing program tools such as Java. Java is known primarily as a server-side programming environment, centered around the technologies that make up the Java 2 Enterprise Edition (J2EE), such as Enterprise JavaBeans (EJBs), servlets, and JavaServer pages (JSPs), and Java 2 Micro Edition (J2ME). More information about J2ME and its implementation in mobile devices is found in by Ortiz and Giguere, 2001, Mobile Information Device Profile for Java 2 Micro Edition, John Wiley & Sons; first edition, New York, which is hereby incorporated by reference herein in its entirety. In some embodiments, the programming platform for the stand-alone sharing program is the Java 2 Micro Edition platform 500 (J2ME). J2ME comprises three core elements: configurations, profiles, and optional packages such as application programming interfaces (APIs). Collectively, a configuration, profile and some optional packages determine the features of Java that can be used, which application programming interfaces (APIs) are available, and how such applications are packaged.

In some embodiments, the host application is designed such that it works well with flash widgets, blogs, or any type of media player. In some embodiments, the host application will work on a content management system (CMS) platform.

5.2.1.3. Exemplary Embodiments of Host Applications

Host application as a Share Button for Users

In some exemplary embodiments, the host application is a share button embedded in a network browser that allows a registered member or an un-registered user to share any content from any web page. For a registered member, the content to be shared can be sent directly to friends and contacts from AIM, e-mail, Facebook, MySpace or other sources. In some embodiments, the shared content is directly posted on a webpage or blog page of the recipient for easy access. In some exemplary embodiments, all content shared by a member with other members or un-registered users is stored and used to determine or update the sharing preference profile of the member or the sharing reference profiles of one or more recipients of the content. The share button embodiment is advantageous in that it does not require participation of the owners of the websites. A member or un-registered user can elect to share any content with another member or an un-registered user through the interface provided by the share button host application. The content may be sent through email or any other communication channels (e.g., instant messaging, short messaging or Facebook and MySpace).

Host Application as WordPress Plugin for Websites (Publisher)

In some embodiments, the host application is one or more types of a WordPress Plugin that owners of a website may elect to include on their site. For example, the WordPress Plugin may be associated with specific content of these websites, including news articles, picture files, and video/audio clips. In such embodiments, the WordPress plugin will be automatically updated with new features. Advantageously, the WordPress plugin thus provides an unobtrusive way for a visitor (to the websites e.g., a member or un-registered user) to send links to desired content from the websites to a friend (e.g., a member or un-registered user) via e-mail or other communication channels (e.g., instant messaging, short messaging or Facebook and MySpace). Also advantageously, the WordPress plugin allows a member or an un-registered user to post content from the websites to various social bookmarking sites such as blog sites, Facebook and MySpace. Another advantage of the WordPress Plugin is that it provides tracking information for monitoring web traffic and for characterizing content shared between members or between a member and an un-registered user.

Host Application as API Plugin for Developers

In other exemplary embodiments, the host application is a JavaScript API for developers that need more control over what is being shared. The JavaScript API provides programmatic control of display options and supports a function based interface. The JavaScript API is designed to accommodate more sophisticated demands from members or un-registered users, for example, when they need to override the default elements within share object properties such as title, URL, summary, content, and etc; or when they want to share multiple objects per page (e.g., images, videos, embedded flash widgets, etc.). The JavaScript API is also helpful when members or unregistered users plan to share something more than just a web page (e.g., image, video, etc.), to change the default object properties, or share multiple objects on a single web page.

5.2.2. Shared Content and Sharing Platforms

The systems and methods of the present invention are adapted for sharing variable types of content (e.g., 220 or 230 of FIGS. 2A and 2B) across different types of communication platforms. Some examples of content that may be communicated between network users includes but is not limited to text messages (e.g., short, “thumbable” message); links (references to other content, e.g., URLs); note messages (page-length, typed message; e.g., an e-mail message); post messages (e.g., notes within a threaded context such as those posted on online discussion boards); files; images (e.g., files of pictures such as digital photos; clips (e.g., files of audio data such as ringtones, mp3 encrypted files, mp4 encrypted files, etc.); video/audio files (e.g., files with stream of image, audio, and caption data such as a home movie file or a mpeg file); and any printable files (e.g., files of text or image date that can be printed to generate hardcopy documents such as fax or printer output documents).

Various types of methods for sharing or communication within and across different platforms have been developed in order to adapt to the diversity of the content that can be shared between network users. Some examples of the sharing or communication platforms include but are not limited to Instant Messages (IM) (e.g., immediate 1:1 private online text message); Short Message Service (SMS) (e.g., immediate or delayed 1:1 private text message between mobile phone users); Multimedia Messaging Service (MMS) (e.g., enhanced data SMS, such as images or ringtones); email (e.g., notes, optionally with file attachments, sent 1:1 or 1:n); fax (printable output via phone); message boards (e.g., interest-based group posting that may be connected to personal or public data such as movie reviews); blogs (e.g., personal message posting on new or current topics, often with boards); social nets (e.g., communications within blogs, boards, and email associated with a users profile); phone (e.g., immediate 2-way such as a dialogue or delayed 1-way such as voice mail communication in audio format); video conference (e.g., immediate 2-way such as a dialogue or delayed 1-way such as video mail communication in video format).

5.2.3. Sharing Interface

A typical sharing interface consists of the following features: a member field for the member to sign in and control the setting of the sharing interface; a recipient field indicating one or more suggested recipients who are available for the member to select as the actual recipients of the content to be shared. In some embodiments, the network identifiers for one or more suggested recipients may be sent to the sharing interface from the remote data server 20 so that a member may select therefrom as the actual recipient of the content to be shared. In some embodiments, the network identifiers may be an email address, a telephone number, an ICQ identification, a Yahoo! messenger identification, an msn messenger identification, a ichat identification, a personalized URL, or an online alias. In some embodiments, a personalized URL may be a blog page, a Myspace page, or a Facebook page. In some embodiments, a member may elect to manually input one or more network identifiers into a text field of the sharing interface. In some embodiments, auto-text programs may be implemented to help the member to complete her manual input and suggest additional recipients from the contact list of the member. In other embodiments, a new network identifier that is not included on the contact list of the member may be entered in the text field of the sharing interface. In some embodiments, the manually entered network identifier will be integrated into the contact list for the member. Similarly, when a member receives content from a network identifier that is not previously included in her contact, the member may choose to include the new network identifier in her contact list. By doing so, the contact list of the member is updated.

In some embodiments, an invitation for joining the meta-community of members may be sent to a recipient (when the recipient is not yet a member to the meta-community of members) along with the content to be shared. In these embodiments, the recipient may choose to register with the meta-community of members and take advantage of the improved methods for sharing information. Once a member is registered, a contact list and accordingly a sharing preference profile will be created for her, both of which are subject to modification such that the sharing preference profile will accurately reflect the interests of the member and the contact list remains update to include all relevant contacts the member intends to maintain.

In some embodiments, a sharing preference profile is created for a recipient who receives information from a registered member of the meta-community even if the recipient is not a registered member. In these embodiments, the sharing preference profile will be created based on the content received by the recipient from one or more registered members.

An exemplary sharing interface is illustrated in FIG. 2C. The description of FIG. 2C is provided as an illustration and should not be construed in any way as limitation to the presently claimed invention. Field 250 displays a title of the content to be shared. In some embodiments, the title will be automatically given, for example, as the title of a web page or the name of a picture file. In some embodiments, the title of the content is determined based on the objects' attributes of the content. In some embodiments, a member chooses to manually input a title indicating the subject of the content to be shared. Field 252 provides an option to the member to select any network identifiers related to recipients directly from the contact list of the member. In field 254 tabs representing different types of network identifiers may be selected. Essentially, a member can choose to select the type of method by which the content will be sent to one or more recipients through field 256 after a network tab is selected. Some examples of sharing methods include, but are not limited to, email, instant messaging, and phone (e.g., as text messages). Field 260 allows the member (e.g., sharer or sender of the content) to enter their own network identifier to which the recipient (e.g., sharee) may respond upon receiving the content to be shared. Field 262 allows the member to enter a personalized message that will accompany the content to be shared to the one or more recipients. Field 264 allows the member (sharer, sender) to send the content to be shared. Field 266 allows the member to send a copy of the content to the member's own network identifier. Field 268 provides additional information and policy guidelines to the members. Advantageously, the above-described sharing interface includes recipient recommendations and content recommendations. For example, field 280 automatically displays which other sharees may benefit from the content that is about to be shared. This can be accomplished for example, based on an analysis of the content to be shared and a comparison of the sharer and sharee's mutual interests. Field 290 provides an indication of what content the sharer's friends have shared recently. Because the sharer's friends and the sharer have mutual interests in common, it is likely that such content will be of interest to the sharer and that the share may know of an additional recipient that may benefit from such information.

Recipient Recommendation In some embodiments, a list of suggested recipients is provided at a sharing interface to a member when the member decides to share content (e.g., in field 280). The list of suggested recipients will be determined based on the sharing preference profiles of the members or users in the meta-community. The methods for determining the sharing preference profile are described in Section 5.4.2.

Content Recommendation In some embodiments, a list of suggested content is provided at a sharing interface to a member when the member decides to share content (e.g., in field 290). The suggested content may be similar in characteristics to that of the content to be shared or content that has been assigned similar characteristics, including commercial content that has similar characteristics. In some embodiments, the suggested content may also be advertisement information that is relevant to the information the member or un-registered user chooses to share.

In some embodiments, content recommendation is done in the context of recipient recommendation. For example, the list of suggested recipients may be selected from network identifiers that are not included in the contact list of the member sharing the particular content. Instead, members or users not listed in the contact list may elect to receive a certain type of content shared within the meta-community by subscribing to a particular group of content characteristics. In some embodiments, the recommended content may be received anonymously by members or unregistered users through such subscription.

Additional description of recipient recommendations and content recommendations is found in Section 5.5.3.

### 5.3. Client Devices, Network, and Network Identifiers

Client devices that are capable of facilitating communication, and hence sharing of content, have been developed in various shapes and sizes. In some embodiments of the present invention, client devices are equipped with network capacity (e.g., through a network device 206 as depicted in FIGS. 2A and 2B). In some embodiments, network device 206 allows the client devices to communicate across different network platform. In some embodiments, multiple network users will be able to use the same client device to communicate so long as each user has a unique network identifier.

5.3.1. Network and Networked Client Devices

FIGS. 1A, 2A and 2B depict exemplary embodiments of a client device (e.g., device 10), in accordance with some embodiments of the present invention. In order to facilitate sharing between client devices and between a client device and a remote data server 20, a client device 10 comprises at least either an embedded host application or a stand-alone host application. Furthermore, a client device 10 comprises at least one network device 206 through which the client device 10 may connect with a network 100. Although a network is generically labeled as an element 100 in FIGS. 1B, 2A and 2B, it is possible that one or more networks are used to connect client devices 10 to a server 20.

Client devices 10 are versatile. So are the networks 100 to which the client devices 10 are connected. For example, client device 10 can be a cell phone, a personal digital assistant (PDA), an iPod, a smart phone, a pager, a television, a media player, a digital video recorder (DVR), or any other networked device. In some embodiments, a client device 10 is a laptop computer or desktop computer. In some embodiments, network 100 is a Internet Protocol Network, an Ethernet network, a DSL network, a wireless network, a cellular network, or any other network that will enable a client device 10 to connect to network services. In some embodiments, network 100 is a personal area network (PAN), a local area network (LAN), a campus area network (CAN), a metropolitan area network (MAN), and/or a wide area network (WAN). In some embodiments, network 100 is a cellular network that uses frequency division multiple access (FDMA), code division multiple access (CDMA), polarization division multiple access (PDMA), or time division multiple access (TDMA) signals. In some embodiments, client device 10 does not have network capacity but is in electrical communication with another device 10 that has network capacity. One example of such a setup is a PDA that is indirectly connected with a network 100 by plugging the PDA into a cradle apparatus that is connected to network 100.

In some embodiments, client devices 10 are portable battery operated handheld devices whose primary source of communication with other devices is through the use of a cellular communication protocol. Examples of client devices 10 include, but are not limited to, cellular telephones, smart phones, pagers, various forms of personal digital assistants (PDAs) and Internet appliances. Typically, a client device 10 weighs less than half a pound and, more typically, weighs less than 5 to 8 ounces.

Exemplary cellular communication protocols in some networks 100 presently include, but are not limited to, cellular communication protocols such as 1G, 2G, 2.5G, 2.75G, 3G, 3.5G 3.75G and 4G. The scope of the present invention is by no means limited by such cellular communication protocols. Any network protocols that are compatible with a client device 10 may be used to implement the systems and method of the present invention. Cellular communication protocols can be used to provide a network 100. The present invention fully encompasses future generations of cellular communication protocols and client devices 10 of the present invention can use any and all such protocols

In some embodiments, client device 10 makes use of a messaging service supported by a cellular communication protocol. For example, in some embodiments, client devices 10 communicate with each other and with a remote data server 20 using short messaging service (SMS) or enhanced messaging service (EMS). Enhanced Messaging Services (EMS) is an enhanced version of Short Messaging Service (SMS) and is comprised of several text messages that are clustered together. EMS provides capabilities for more rich messaging features such as sending/receiving ringtones and other melodies/sounds, pictures and animations, and modified (formatted) text. In some embodiments, client device 10 communicates with remote data server 20 using multi-media messaging services (MMS).

Developments in technology and programming languages have allowed applications to be stored locally on client device 10 so that they may be executed when the user is outside an area where network coverage is provided. However, these applications stored locally on client device 10 are sometimes limited by the compact nature of the devices. For example, client device 10 have limited user interfaces, such as small screens and condensed keyboards. Additionally, client device 10 may be limited to very small amounts of memory, sometimes a few hundred kilobytes.

5.3.2. Network Identifiers and Interactions Among them

In some embodiments in accordance with the present invention, a network identifier offers a way to personally identify a network user and thus permit efficient communication as well as privacy protection. In some embodiments, a network user may be equipped with multiple network identifiers. For example, a person may have multiple email addresses, multiple instant messenger identifiers, multiple phone numbers and multiple personalized uniform resource locations (such as blogs, Facebook pages, or MySpace pages).

It has been noted that cross-the-platform communication may be difficult to establish. For example, there are no easy ways for a network user to post content that the user wants to share on a friend's blog page or Facebook wall using a cellular phone. By establishing a cross-the-platform program, specific for sharing, the instant invention improves sharing of content among network users. In one example, after identifying the content a user wants to share (e.g., using a cell-phone based network browser), the user may launch a sharing interface, either as an embedded program of the network browser or another program or as a stand-alone sharing program. On the sharing interface, the user in this example is given the choice of posting on personalized URL such as a blog page, a MySpace page or a Facebook wall. The identification of recipients of the content may be done automatically on a remote date server, or manually, but may take advantage of auto-text program to easily identify recipients from the user's own contact list.

In some embodiments, the instant invention implements simple and efficient sharing by integrating a social networking framework and a client with a message junction network. In particular, the message junction network removes the message limitation by connecting previously unrelated networks (e.g., SMS to MySpace post); re-formatting/transcoding content types (e.g., re-size image for MMS); storing and forwarding when needed through a collection of shared content (e.g., stored in a ShareBox associated with the member) which never gets in the way of the recipient with annoying delays, advertisements, or registration requests (e.g., photos may be sent directly to email recipients whereas a link may be sent to IM recipients); and enabling broadcast of messages to groups of friends (e.g., IM to my MySpace friends).

### 5.4. Remote Data Server

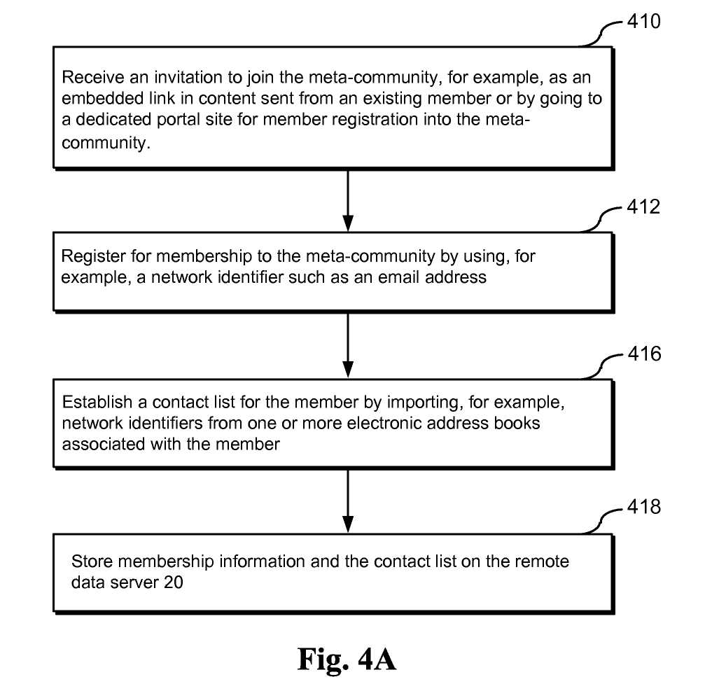

FIG. 2B illustrates an embodiment of a remote data server 20 which exchanges information with a client device 10. A remote data server 20 means, in various embodiments, a device that is different or separate from a client device 10. Remote data server 20 is able to communicate with client devices 10 through a network 100. For example, a remote data server 20 can be located in the same room, same building, or same city as a client device 10. A remote data server 20 stores the user profiles of a plurality of register users of a meta-community and each register user of a meta-community typically interfaces with the meta-community using client devices 10, remote date server 20, and network 100. The information exchanged between a client device 10 and a remote server 20 across a network 100 includes information associated with the content transferred and/or the sender and recipient of the content. FIG. 3 illustrates a more detailed view of remote data server 20 that supports the functionality described above and detailed in sections below.

5.4.1. Structure and Functionality of Remote Data Server

In some embodiments in accordance with the present invention, a remote data server 20 as depicted in FIG. 2B comprises a contact database 354 (e.g., for storing contact lists for all members of the meta-community), a sharing record database 358 for storing information associated with all sharing that has taken place between members of the meta-community, and a member sharing preference profile 360 that contains information about the sharing interests of each member in the meta-community of members. A more complete depiction of an exemplary remote data server 20 is shown in FIG. 3 and discussed below.

5.4.2 Remote Data Server

In some embodiments, remote data server 20 may comprise a central processing unit 310, a power source 312, a user interface 320, communications circuitry 316, a bus 314, a non-volatile storage controller 326, an optional non-volatile storage 328, and a memory 330.

Memory 330 may comprise volatile and non-volatile storage units, for example random-access memory (RAM), read-only memory (ROM), flash memory and the like. In some embodiments, memory 330 comprises high-speed RAM for storing system control programs, data, and application programs, e.g., programs and data loaded from non-volatile storage 328. It will be appreciated that at any given time, all or a portion of any of the modules or data structures in memory 330 can, in fact, be stored in memory 328.

User interface 320 may comprise one or more input devices 324, e.g., keyboard, key pad, mouse, scroll wheel, and the like, and a display 322 or other output device. A network interface card or other communication circuitry 316 may provide for connection to any wired or wireless communications network 100 (e.g., FIG. 1B). Internal bus 314 provides for interconnection of the aforementioned elements of the remote data server 20.

In some embodiments, operation of remote data server 20 is controlled primarily by operating system 332, which is executed by central processing unit 310. Operating system 332 can be stored in system memory 330. In addition to operating system 332, a typical implementation of system memory 330 may include a file system 334 for controlling access to the various files and data structures used by the present invention, one or more application modules 336, and one or more databases or data modules 350.

In some embodiments in accordance with the present invention, applications modules 336 may comprise one or more of the following modules described below and illustrated in FIG. 3.

Data processing application 338. In some embodiments in accordance with the present invention, a data processing application 338 receives and processes content shared between client devices 10 and between a client device 10 and remote data server 20. For example, identifiers of the content transferred between client devices 10 are sent and stored by remote data server 20, thereby forming a sharing record database 358. Shared records of each member in the meta-community of members are delivered to remote data server 20 from client devices 10. The sharing records, once received, are processed to extract the essential features to generate sharing data templates to be used as bases for predicting sharing preference profiles (e.g., profiles with sharing interests) for each member. In some embodiments of the present invention, sharing records contain identifiers (e.g., web URLs) of the content that is shared between client devices 10. In some embodiments, when more complex data is shared between client devices, additional tools may be necessary to extract information from the shared content to allow a sharing preference profile be created for the members who send the content. In some embodiments, a hash function is used to perform the information extraction.

In some embodiments, content received by members may also be used to determine the sharing preference profiles. In some embodiments of the present invention, content received by a member is considered passive and is not given the same weight as content sent by the same member when determining the user profile of the member.

By applying computation techniques (e.g., hash functions), data processing application 338 turns raw content shared between members into digital data to construct one or more sharing databases (e.g., 358).

In some embodiments, data processing application 338 utilizes a chromosome-like system and method for determining member/user characteristics such as any of those disclosed in U.S. patent application Ser. No. 11/664,710, filed on Oct. 11, 2005, which is hereby incorporated by reference herein in its entirety. In some embodiments, data processing application 338 utilizes a clustering method for determining member/user characteristics from content that the member has shared and/or received. Details of exemplary clustering methods are disclosed in Section 5.6.2.

Content management tools 340. In some embodiments, content management tools 340 are used to organize different forms of content databases 352 into multiple databases, e.g., a content database 354, a content category database 356, a sharing record database 358, a member sharing preference profile database 360, and an optional user password database 362. In some embodiments in accordance with the present invention, content management tools 340 are used to search and compare any of the databases hosted on remote data server 20. Content in accordance with the present invention may be, for example, a text message, a URL, a web link, a note message, a post message, a file, an image, an audio file, a video file, a flash file, a media file, a slideshow file, any printable file, or any ASCII or binary file or data structure.

The databases stored on remote data server 20 comprise any form of data storage system including, but not limited to, a flat file, a relational database (SQL), and an on-line analytical processing (OLAP) database (MDX and/or variants thereof). In some specific embodiments, the databases are hierarchical OLAP cubes. In some embodiments, the databases each have a star schema that is not stored as a cube but has dimension tables that define hierarchy. Still further, in some embodiments, the databases have hierarchy that is not explicitly broken out in the underlying database or database schema (e.g., dimension tables are not hierarchically arranged). In some embodiments, the databases in fact are not hosted on remote data server 20 but are in fact accessed by centralized data server through a secure network interface. In such embodiments, security measures such as encryption is taken to secure the sensitive information stored in such databases.

In some embodiments, content management tools 340 utilize a chromosome-like system or method for determining member/user characteristics such as any of those disclosed in U.S. patent application Ser. No. 11/664,710, filed on Oct. 11, 2005, which is hereby incorporated by reference herein in its entirety.

In some embodiments, content management tools 340 utilize a clustering method for determining member/user characteristics. Details of exemplary clustering methods are in Section 5.6.

System administration and monitoring tools 342. In some embodiments in accordance with the present invention, the system administration and monitoring tools 342 administer and monitor all applications and data files of remote data server 20. To ensure that the information that is shared between members of a meta-community is kept private, access to shared content and information about who shared this content is preferably strictly controlled. System administration and monitoring tools 342 control which servers or devices have access to remote data server 20. In some embodiments, security administration and monitoring is achieved by restricting data download access from remote data server 20 such that the data is protected against malicious access. In some embodiments, system administration and monitoring tools 342 use more than one security measure to protect the data stored on remote data server 20. In some embodiments, a random rotational security system may be applied to safeguard the data stored on remote data server 20.

Network application 346. In some embodiments, network applications 346 connect a remote data server 20 to multiple network services. Referring to FIG. 1, in some embodiments, a remote data server 20 is connected to multiple types of client devices 10, which requires that remote data server 20 be adapted to communication with different types of network interfaces, for example, router based computer network interfaces, switch based phone like network interfaces, and cell tower based cell phone wireless network interfaces. In some embodiments in accordance with the present invention, upon recognition, a network application 346 receives data from intermediary gateway servers before it transfers the data to other application modules such as data processing application 338, content management tools 340, and system administration and monitoring tools 342.

Customer Support Tools 348. Customer support tools 348 assist users with information or questions regarding their accounts, technical support, billing, etc. In some embodiments, customer support tools 348 may allow a member to manually input or select the member's interest category to facilitate better characterization of the member's sharing preference profile.

In some embodiments, each of the data structures stored on the remote data server 20 is a single data structure. In other embodiments, any or all such data structures may comprise a plurality of data structures (e.g., databases, files, and archives) that may or may not all be stored on remote data server 20. The one or more data modules 350 may include any number of databases 352 organized into different structures (or other forms of data structures) by content management tools 340.

In addition to the above-identified modules, data 350 may be stored on remote data server 20 or on a computer that is addressable by remote data server (e.g., any computer that the remote data server can send information to and/or retrieve information from). Such data comprises content databases 352 and member data 364. Exemplary databases 352 include, but are not limited to, contact database 354, content category database 356, sharing record database 358, member sharing preference profile database 360, and optional member password dataset 362, which are described below in more detail.

Contact Database 354. For every member in the meta-community, a contact list is established to include all network identifiers and the owners/users of the network identifiers with whom the member has communicated. As described in the member registration process in Section 5.5, in some embodiments, a contact list for the member may be created automatically, for example, by importing existing online address books associated with the member including, but not limited to, a gmail address book, a Yahoo! Mail address book, a hotmail address book, an IM address book, an outlook address book, a msn address book, a Mac OS X address book, a Windows address book. Further, a contact list can be generated from an online email address book, an online chat address book, an online messenger address book, an email program address book, or an operating system address book, or any other electronic address book that is associated with the member.

In some embodiment, a contact list in accordance with the present invention is a combination of all online address books associated with the particular member to which the member grants the system access. In some embodiments, the contact list is organized alphabetically by the names of the owners/users of the network identifiers. In other embodiments, the contact list is organized by category and sorted by types, for example, as email address, IM identifiers, phone numbers, etc. In some embodiments, the contact lists of all members in the meta-community of members are organized into a searchable database (e.g., contact database 354 in FIGS. 2B and 3). In some embodiments, contact database 354 is stored on, and managed by, programs of remote data server 20. In some embodiments of the present invention, contact database 354 may be searched by a data processing application 338. In some embodiments of the present invention, contact database 354 may be maintained, updated and managed by content management tools 340. In some embodiments, each time a new network identifier is inputted by the member, the contact list associated with the member is updated. In such instances, contact database 354 will also be updated accordingly.

Content category database 356. In some embodiments, remote data server 20 hosts a content category database 356. Content category database 356 contains categorized information of all types of content that may possibly be shared in accordance with the present invention. In some embodiments, content shared between two members or between a member and an un-registered user may be used based on the content category database 356. In some embodiments, the categorized content in content category database 356 is represented by one or more identifiers. In some embodiments, the content is represented by their URLs. Once categorized, the shared content may be used to deduce possible interests of the members that are associated with the content. In some embodiments, content that is sent by a member will be given more weight in determining the member's interests than the content received by the same member. In some embodiments, a member's interests may be deduced by matching content shared by the member with categorized content in content category database 356.

In some embodiments, existing web-crawling data may be used to categorize content on websites in order to construct content category database 356. In some embodiments, traffic to websites may be used to construct content category database 356. For example, content on a website may be characterized based on the popularity of the content, e.g., how often the content is accessed by Internet traffic. In some embodiments, content category database 356 will be periodically updated to reflect changes in website content and in Internet traffic. Methods such as clustering techniques, for example, those as described in Section 5.6, may be used to characterize content category.

Sharing Record Database 358. In some embodiments, all sharing records associated with sharing processes between members of the meta-community or between members and un-registered users are submitted to the remote data server 20. In some embodiments, all sharing records associated with sharing processes between members of the meta-community or between members and un-registered users are stored on the remote data server 20. In some embodiments, the sharing records of members are organized into sharing record database 358. In some embodiments, the sharing records are only stored for a predetermined period of time (e.g., a year or less, a month a less, a week or less, etc.). In some embodiments, content management tools 340 may be employed to update the sharing records. In some embodiments, partial or complete collection of the sharing records associated with a member may be provided to the member (e.g., in an archive format as collected record(s) for the member). For example, the member will be able to review sharing records in the collected record(s) for a given time period, such as three months or less, six months or less, or one year or less. In some embodiments, the member will able to delete the sharing records or share the content related to the sharing records with additional recipients. It is also possible to store sharing records for un-registered users on the remote data server 20. In some embodiments, sharing record data for an un-registered user are not as extensive as a registered member. For example, in one nonlimiting embodiment, only content sent to the un-registered user from a registered member is recorded.

Member sharing preference profile database 360. In some embodiments in accordance with the present invention, at least one member sharing preference profile is created for each member in the meta-community. In each preference profile, the sharing interest of the member is included. In some embodiments, such interests are determined based on a plurality of sharing records of the particular member. In some embodiments, such interests are determined based on all sharing records of the particular member through an automated learning program that analyzes sharing data and predicts, determines, or updates sharing preference profiles according to the analyses. In some embodiments in accordance with the present invention, the automated learning program is located on a remote server. Sharing data that is suitable for analysis by the automated learning program may be passive or active behavioral data. For example, in some embodiments, the automated learning program determines a member sharing preference profile by monitoring the content read, stored, or shared by the member, searching the member computer for content, or by other means. In some embodiments, standard web crawling data may be used by the automated learn program. In embodiments where shared content is used to determine a sharing preference profile, both content received or sent by a member may be used. Content sent by an un-registered user cannot be monitored. However, a tentative sharing preference profile can still be determined for an un-registered user based on content received by this un-registered user from registered members. The tentative sharing preference profile can then be modified and updated once the un-registered user signs up and becomes a member to the meta-community. Alternatively, a member sharing preference profile may be defined by a member personally, for example, by filling out questionnaires when the member registers for membership in the meta-community of members in accordance with some embodiments of the present invention. In some embodiments of the present invention, a member may manually select items on a list of interests to create a member sharing preference profile.

In some embodiments of the present invention, the automated learning program utilizes a chromosome-like system and/or method for determining member/user characteristics such as any of those disclosed in U.S. patent application Ser. No. 11/664,710, filed on Oct. 11, 2005, which is hereby incorporated by reference herein in its entirety. In some embodiments, the automated learning program utilizes information determined by data processing application 338 and content management tools 340. In some embodiments, the automated learning program utilizes a clustering method for determining member/user characteristics. In some embodiments, the automated learning program utilizes a linear or non-linear regression method or a decision tree method. Details of exemplary methods for automated learning are included in Section 5.6.

In some embodiments, a sharing preference profile of a member is determined based on all sharing records associated with the member, including the content received by or sent from the member. In some embodiments, the sharing preference profile is updated or modified when the member sends or receives new content. In some embodiments, the tentative sharing preference profile of an un-registered user may also be updated or modified after the un-registered user receives new content from one or more members.

Still alternatively, in some embodiments, a member selects security settings to instruct the system when and how to perform the automated interest learning process, as well as to specify what types of content they wish to share and/or receive. This may include the ability to tell the system to temporarily stop “watching” the user to avoid learning about their interest in a topic and/or sharing content. This feature is particularly useful in the more automated forms of the system. In some embodiments, this feature may be used for topics of some sensitivity, in which the member doesn't want personal interests recorded. The method may also be useful for topics of only transient interest, about which the member doesn't want or need to collect information in the future. Other settings may include whether to reveal the member's name to those who are sharing the content, control over what types of the member's activities should be monitored (e-mails, web surfing, local file storage, etc.), how close a user has to be in the network to become a sharing partner to the member (e.g., a “friend,” a “friend of a friend,” a “friend of a friend of a friend,” anyone in the network), etc. In some embodiments, the degree of separation between members may also be utilized to learn the interests or sharing preference profile of the members.

In some embodiments, a combination of two or more of the above-mentioned methods is used to define a member preference profile. In some embodiments, all preference profiles are compiled to form a searchable database member sharing preference profile database 360.

Member security database 362. In some embodiments in accordance with the present invention, a member security database 362 may be created and stored on remote data server 20 where passwords of the members are stored and managed. In some embodiments, members are given the opportunity to choose security settings.

5.5. Exemplary Embodiments for Meta-Community-Based Sharing Between Members

The systems and methods in accordance with the present invention that are disclosed herein allow members of a meta-community to easily and efficiently share content not only among members of the meta-community but also un-registered users of the meta-community. In some embodiments, a system is created which reduces the process of sharing relevant information to a single action (for example a mouse click) or even potentially to a completely automated action as described herein. In some embodiments, when a member sees content to be shared in a web page, the member simply clicks a button associated with the web page and/or the browser hosing the web page on a client device 10 to indicate that the content is “worth sharing.” The system can then analyze the content and cross-reference this analysis with the interests of each user in the meta-community. The system then sends the content to each member in the meta-community to whom it would be of interest, using the system's information about how to send the content to each member, and optionally taking into account security settings for each member. Such security setting determine, among other things, for the “sending” member, whether the content should be sent at all and for the “receiving” member, whether the content should be sent to that member.

Alternately, though less preferred, the first step of the above-described process, where the member clicks to indicate content of interest, is replaced with an automated system which either (i) learns what types of content is interesting to people in the meta-community and automatically initiates the sharing whenever any member in the meta-community comes across those types of content or (ii) determines content of interest by watching the member's behavior. For example, the latter technique could involve monitoring a member's Internet use (e.g., determining which web sites the member proactively navigates to when the user surfs the Internet).

Still alternatively, some embodiments of the present invention employ a semi-automated mechanism. For example, the system may signal a viewing member when the viewing member (sharer) is looking at content that would be of interest to another member in the network. The viewing member could then decide whether or not the content is of high enough quality to warrant sharing, and if so, to initiate the sharing as described here or via another mechanism.

5.5.1 Member Registration and Communities of Members

An exemplary interface for membership registration or signing in is depicted in FIG. 2D. An exemplary process for acquiring membership to a meta-community in accordance with the present invention is illustrated in FIG. 4A. The following description is provided by way of example and should not be construed as specific limitations to the present invention.

Step 410. In some embodiments, an un-registered user with one or more network identifiers receives an invitation from an existing member, for example, embedded in the content the existing member shares with the un-registered users. In other embodiments, an un-registered user may come across an invitation through an Internet search or by other electronic means.

Step 412. In some embodiments, the membership registration may be done through the sharing interface depicted in FIG. 2D. In some embodiments, the un-registered user may register to be a member through one or more network identifiers owned by the un-registered user, for example, using an email address. Once registered, the new member may input additional network identifiers that will all be associated with the new member.

Step 416. A contact list for the member may be created by importing existing online address books associated with the member including, but not limited to, a gmail address book, a Yahoo! Mail address book, an IM address book, an outlook address book, a Microsoft network address book or any other electronic address book. In some embodiments of the present invention, a contact list is an aggregation of all online address books associated with the particular member. In some embodiments, the contact list is organized alphabetically by the names of the owners/users of the network identifiers. In some embodiments, the contact list is organized by category and sorted by type, for example, as email address, instant message identifier, phone number, etc. In some embodiments, the contact lists of all members in the meta-community are organized into a searchable database (e.g., contact database 354 in FIGS. 2B and 3).

Step 418. In some embodiments of the present invention, once registration is completed, the membership information including the contact list is stored.

5.5.2. Sharing Preference Profiles

In some embodiments, a member's interests in content are described in a sharing preference profile that is stored on the remote data server. A sharing preference profile can be determined based on passive data (e.g., data associated with web browsing, key stroke history/preference, Clickstreams, Lifestreams, or RSS) or active data (e.g., actively shared content or search history and preference data). In some embodiments, such interests are determined based on a plurality of sharing records of the particular member. In some embodiments, such interests are determined based on all sharing records of the particular member through an automated learning program. In some embodiments, the automated learning program determines a member sharing preference profile by watching the content read, stored, or shared by the member, searching the device 10 associated with the member for content, and/or by other means. A sharing preference profile is updated as more passive data or active data become available for the member, e.g., the owner of the sharing preference profile. A sharing preference profile does function in isolation: it exists in the meta-community setting. For example, when a member of a meta-community chooses to share content, both the sharing preference profile of the member (e.g., sharer) and the sharing preference profiles of other users of the meta-community (e.g., members and un-registered users in the contact list of the sharer) will be evaluated. Evaluation of the former provides content recommendation (e.g., what other content may be member also be interested in) while evaluation of the latter provides recipient recommendation (e.g., which users in the member's contact list may also be interested in receiving the content to be shared).

Alternatively, a member sharing preference profile is defined by a member personally, for example, by filling out questionnaires when the member registers for membership in the meta-community in accordance with the present invention. In some embodiments, a member manually selects items from a list of interests in order to create a member sharing preference profile.

Still alternatively, in some embodiments, a member selects security settings to specify how and when to perform automated interest learning, as well as to specify what types of content are be shared and/or received. This may include the ability to temporarily halt monitoring of the member's activities at specific times or under specific conditions in order to avoid learning about the member's interests. Such a feature is particularly useful in the more automated forms of the system. In some embodiments, this is used for topics of some sensitivity, in which the member doesn't want personal interests recorded in a profile. This feature is also useful for topics of only transient interest, about which the member doesn't want or need to collect information in the future. Other settings may include whether to reveal the member's name to recipients of the shared content, control over what types of the user's activities should be monitored (e-mails, web surfing, local file storage, etc.), how close a member has to be in the meta-community to become a sharing partner (e.g., a “friend,” a “friend of a friend,” a “friend of a friend of a friend,” anyone in the network), etc. In some embodiments, the degree of separation between members may also be utilized to learn the interests or sharing preference profile of the members.

In some embodiments, a combination of two or more of the above-mentioned methods is used to define a member sharing preference profile. In some embodiments, all preference profiles are compiled to form a searchable database member preference profile database 360.

In some embodiments in accordance with the present invention, more than one member sharing preference profiles are created for a member in the meta-community. In these embodiments, each of the member sharing preference profile is specialized for a certain type of information sharing. For example, a first member sharing preference profile may be specific for file sharing with other members or un-registered users of the meta-community; e.g., the first sharing preference profile provides recipients recommendation when the member chooses to share content with others. A second member sharing preference profile may be for advertisements that are of interest to the member; e.g., the second member sharing preference profile provides content recommendation (e.g., advertisement content) to the member.

Attention Profiling Mark-up Language (APML) is an XML-based format for capturing a person's interests and dislikes. APML provides personal attention profiles that can be shared among owners of APML. An APML profile is different from a sharing preference profile in many ways. An APML profile is created at the user end and adopted by web services on a case by case basis. The owner of an APML profile chooses to share the profile with owners of other APML profiles. Most importantly, an APML will not be evaluated in a meta-community setting as the sharing preference profiles are. Neither recipient recommendation nor content recommendation will be provided based on an APML profile.

Exemplary processes for creating sharing preference profiles are depicted in FIG. 4B.

Step 430. Each time a sharing process occurs in which a member of a meta-community sends or receives content via a sharing interface through a host application on a networked client device, a sharing record is submitted to remote data server 20. The sharing record is specifically associated with the member and comprises at least an identifier for the shared content. In some embodiments, partial or complete collection of the sharing records associated with a member may be accessed by the member. In some embodiments, the member can review the sharing records and delete select sharing records or share the content identified in such sharing records with additional recipients.

Step 432. At the remote data server, a search is launched to ascertain whether a sharing preference profile has been created for the member.

Step 434. When there already exists on the remote data server a sharing preference profile for the member, the received sharing record received will be used to update or modify the existing sharing preference profile to expand or more accurately reflect the interests of the member.

Step 436. When a sharing preference profile does not exist for the member, it will be created on remote data server 20. In some embodiments, the sharing preference profile for each respective member in the meta-community is based on all sharing records associated with the respective member. In some embodiments, the sharing preference profile comprises a plurality of categories of interest (e.g., one or more categories of interest, two or more categories of interests, between one and one hundred categories of interest) that are associated with the particular member of the meta-community.

Step 438. Once created, sharing preference profiles, and in some embodiments the sharing records associated with such sharing preference profiles, are stored on the remote data server 20. In some embodiments, the sharing preference profiles are updated whenever new sharing records are generated and received by the remote data server 20. In some embodiments, the sharing preference profiles are updated on a periodic basis (e.g., monthly, weekly, daily, hourly, etc.). In some embodiments, the sharing records are also updated on a periodic basis (e.g., monthly, weekly, daily, hourly, etc.). For example, old sharing records may be purged after a predetermined period of time, such as one month, three months, six months, a year, or longer.

5.5.3. Exemplary Sharing Processes

In accordance with the present invention, a sharing process is initiated by the sender of the information or content to be shared (e.g., the sharer). An exemplary sharing process is depicted in FIGS. 4C and 4D. The following description is provided by way of example and should not be construed as specific limitations to the present invention.

Step 450. A member sends to the remote server a request for sharing by identifying the content to be shared (e.g., the original content to be shared). For example, the member may elect to share an article on ski techniques. In some embodiments, the request is submitted via a sharing interface that is embedded in a network browser. In other embodiments, the request is sent via a sharing interface that is a stand-alone program.

Step 452. A search program is launched on the remote data server. The program searches one or more databases on the remote data server to identify a plurality of suggested recipients for the content by matching the known interests of the recipients and the content to be shared. In some embodiments, the plurality of suggested recipients is determined automatically without human intervention. For example, the recipients will be some or all members or un-registered users in the contact list of the member who has either received or sent information related to skiing. Alternatively, or additionally, a search program is launched on remote data server 20 to identify additional content to be shared by comparing the characteristics of the content from step 450 to the characteristics of content that has been shared in the meta-community. For example, in some embodiments, this suggested share content is identified based on some or all of the content shared by members or unregistered users in the contact list of the member from step 450. The additional suggested share content may be similar to the content identified at step 450. For example, the suggested share content may comprise ski tips, ski equipment, or information related to skiing resorts that have been shared between members or unregistered users in the contact list of the member. In some embodiments, the suggested share content may contain information related to commercial advertisements that are relevant to the content identified in step 450. For example, the suggested share content may contain information related to stores for selling or renting ski equipment, top ski resorts, plane tickets or hotel information for such resorts and much more.

The search for suggested share content, including advertisements that will be shared, can be done independently of the search for suggested recipients of the original content to be shared. For example, the search for suggested share content can be performed before, after, or even in the absence of the identification of suggested recipients.

Step 455. The process may bifurcate depending on whether a plurality of suggested recipients has been successfully identified in step 452. In some embodiments, additional suggested share content may be provided in the absence of, or in addition to, a plurality of suggested recipients.

Step 460. If a plurality of suggested recipients is identified on remote data server 20 (step 455—Yes), a list containing the suggested recipients will be proposed to the member through a sharing interface on the client device 10 associated with the member. In some embodiments, suggested additional share content is also proposed to the member through the sharing interface. The suggested additional share content may be provided at the same time that the suggested recipients are provided or at a different time or even in absence of any presentation of a plurality of suggested recipients. In some embodiments, the suggested additional share content comprises content that is similar to the content to be shared. In other embodiments, the suggested additional share content comprises advertising content related to the content to be shared.

Step 462. After step 460, the member is given the choice to select, among the plurality of suggested recipients, one or more actual recipients to receive the original content to be shared. In some embodiments, the member is given the choice to select additional content to be shared from the suggested additional share content. In some embodiments, the member elects to manually enter one or more network identifiers as the recipients of the original content to be shared. In some embodiments, the member elects to manually enter one or more network identifiers as the recipients of the original content to be shared and to select additional actual recipient from the plurality of suggested recipients.

Step 466. In step 466, which occurs upon a logical condition of “yes” in step 462 (step 462—Yes), the member selects from the list of suggested recipients, one or more actual recipients to receive the original content to be shared. In some embodiments, the member may still elect to enter one or more recipients manually on a text input field provided on the sharing interface. In some embodiments, additional content is selected from the suggested additional share content, including advertisement information relevant to the content to be shared. In embodiments where no additional recipients are selected, additional content may still be sent to any member or user the member enters at the sharing interface.

Step 458. If a plurality of suggested recipients cannot be identified (step 455—No) or the member cannot identify one or more actual recipients from among a plurality of suggested recipients (step 462—No), the member is prompted to enter one or more recipients manually in a text input field provided in the sharing interface prior to step 468.

Step 468. The original content to be shared is transmitted to the actual recipients through the sharing interface via networked client devices. In some embodiments, additional suggested content is sent to these recipients. In other embodiments, the actual content is not sent to the recipients. Instead, an identifier, such as a URL or link, is sent to the recipients. In some embodiments, any additional content in the suggested addition share content, including advertisements information relevant to the shared content, is also be sent to the one or more recipients.

Step 470. Records concerning the sharing process are submitted as a new sharing record to the remote data server 20. Such sharing records are analyzed for discovery of new sharing preference characteristics or to update/modify existing sharing preference characteristics. In some embodiments, methods disclosed in Sections 5.4 and 5.6, alone or in any combination, may be used to characterize the sharing records.

Step 472. In some embodiments, the sharing preference profile is updated to incorporate information from the new sharing record.

As demonstrated above, because each member has a sharing preference profile, with the potential of further refinement as more content is shared in the future, the systems and methods of the present invention allow a system or process to acquire have considerable knowledge of the interests and sharing preferences of the members of a meta-community. Thus, it will no longer be necessary for members of the meta-community to form close relationships with each other in order to receive relevant information. By doing so, the current invention enhances relevance of the content shared between members of a meta-community.

5.5.4. Sharing Characteristics of Content and Characteristics Matching

As discussed hereinabove, a member's sharing preference can be defined by passive data (e.g., content visited or viewed by the member) or active data (e.g., content sent, received or searched by the member). As such, characterization of content is relevant to both characterization of interests as well as to matching of such characteristics for content or recipient recommendation. Content characteristics can also be determined passively or actively. In passive determination embodiments, characteristics of content on a website may be determined based on characterization of the website. For example, content on portal web site (e.g., Yahoo! front page) may be broken into broad categories including “News,” “Sports,” “Finance,” “Music” and “Real Estate.” When a user shares content in the “News” portion of the website with sharees, the content is deemed to have the characteristic “News” and the system records in the sharing preference profiles of the sharees whether sharees are accepting content that is characterized as “News.” Furthermore, the fact that that the sharer is sharing content that is characterized as “News” indicates that the sharer is interested in “News” and this characteristic is added to the sharer's sharing preference profile if the share consistently shares content that is categorized as “News.”

In some embodiments, a content recommendation or recipient recommendation is made by matching the content characteristics in the sharing preference profiles of potential sharees with the content characteristics in the preference profile of the sharer. For example, if sharer A and potential sharee B have similar or identical characteristics listed in their respective preference profiles, then member B will be recommended as a sharee to sharer A when sharer A is sharing content. In another example, if sharer A is sharing content that has a particular characteristic and this characteristic is associated with a potential sharee B because it is listed in sharee B's preference profile, then sharee B will be recommended as a potential sharee for the content.

More sophisticated methods, such as heuristic algorithms, may be used to further characterize content based on, for example, user access activities. For example, after monitoring website traffic to Yahoo! Music, it may be possible to conclude that users who enjoy content a (e.g., Billy Joe music) and content b (e.g., Paul Simon music) are also likely to enjoy content c (e.g., Bob Dylan music). As such, an additional level of characterization may be possible to connect content c with either content a and content b, or with both content a and content b. Such discovery may be helpful for content recommendation. For example, if the sharing preference profile of a member indicates interests in content a and content b, it may be reasonable to present content c to the member as a possible content recommendation. Additional methods may be used to uncover inherent connection between variant content and thus provide more accurate recipient recommendation or content recommendation.

Content characteristics may also be determined using a pattern classification algorithm and/or statistical algorithm such as a decision tree, predictive analysis of content preference for a given member, a multiple additive regression tree, a neural network, a clustering algorithm, principal component analysis, a nearest neighbor analysis, a linear discriminant analysis, a quadratic discriminant analysis, a support vector machine, an evolutionary method, a projection pursuit, a radial basis function, weighted voting, etc.

Similarity metrics may be used to match sharing preference profiles or to match content characteristics. Detailed methods for computing similarity metrics are included in Section 5.6.3.

5.5.5. Additional Features

In some embodiments, members may choose to safeguard their privacy by allowing only some of their interests to be known to the other members of the meta-community, or to be known to only some but not all of the members of the meta-community. In some embodiments, specific advertisement may be directed to a recipient member based on the interests or sharing preference of that member. In some embodiments, security features may be implemented to block unwanted information sharing such as random spam or solicitation.

5.6 Exemplary Methods and Systems

Exemplary methods and systems suitable for implementing the present invention are disclosed in this section.

5.6.1 Hash Function

A hash function (or hash algorithm) is a reproducible method of turning data (usually a message or a file) into a number suitable to be handled by a computer. Hash functions provide a way of creating a small digital “fingerprint” from any kind of data. The function chops and mixes (e.g., bit shifts, substitutes or transposes) the data to create the fingerprint, often called a hash value. The hash value is commonly represented as a short string of random-looking letters and numbers (e.g., binary data written in hexadecimal notation). A good hash function is one that yields few hash collisions in expected input domains. In hash tables and data processing, collisions inhibit the distinguishing of data, making records more costly to find. Hash functions are deterministic. If two hash values derived from two inputs using the same function are different, then the two inputs are different in some way. On the other hand, a hash function is not injective, e.g., the equality of two hash values ideally strongly suggests, but does not guarantee, the equality of the two inputs. Typical hash functions have an infinite domain (e.g., byte strings of arbitrary length) and a finite range (e.g., bit sequences of some fixed length). In certain cases, hash functions can be designed with one-to-one mapping between identically sized domain and range. Hash functions that are one-to-one are also called permutations. Reversibility is achieved by using a series of reversible “mixing” operations on the function input. If a hash value is calculated for a piece of data, a hash function with strong mixing property ideally produces a completely different hash value each time when one bit of that data is changed.

5.6.2 Clustering Methods

In some embodiments, data processing application 338 utilizes a clustering method for determining member/user characteristics from content that the member has shared and/or received. In particular, content characteristics can be categorized by clustering web access activities to a website. Characteristics of content may be clustered (or grouped) on a user specific basis. For example, user-specific content access data to a website (e.g., based on IP address) may be clustered to reveal heuristic connection between content characteristics. For example, access activities by a same user may be signed the same color and the content accessed will be clustered using a two-dimensional agglomerative clustering technique. This type of clustering is particularly helpful for determining a sharing preference profile for a particular member/user and accordingly predicting content preference for the member/user (e.g., through content recommendation).

In other embodiments, characteristics of the shared and/or received content p are compared to predetermined characteristics categories q based on a pairwise probability function. In these embodiments, characteristics in different categories of two sharing preference profiles are assigned priority values. For example, consider the case in which ten priority values for ten corresponding content characteristics in members X and Y are used. Each member will have priority values for each of the ten categories of content characteristics. Such values can be used to define the vector:

### X₁ X₂ X₃ X₄ X₅ X₆ X₇ X₈ X₉ X₁₀

where Xᵢ is the priority value of the i^{th} category of content characteristics in member X. Similar assignment may be done for member Y. The pairwise probability function may be constructed based on clustering methods described on pages 211-256 of Duda and Hart, Pattern Classification and Scene Analysis, 1973, John Wiley & Sons, Inc., New York, (hereinafter “Duda 1973”) which is hereby incorporated by reference in its entirety. As described in Section 6.7 of Duda 1973, the clustering problem is described as one of finding natural groupings in a dataset. To identify natural groupings, two issues are addressed. First, a way to measure similarity (or dissimilarity) between two samples is determined. This metric (similarity measure) is used to ensure that the samples in one cluster are more like one another than they are to samples in other clusters. Second, a mechanism for partitioning the data into clusters using the similarity measure is determined.

Similarity measures are discussed in Section 6.7 of Duda 1973, where it is stated that one way to begin a clustering investigation is to define a distance function and to compute the matrix of distances between all pairs of samples in a dataset. If distance is a good measure of similarity, then the distance between samples in the same cluster will be significantly less than the distance between samples in different clusters. However, as stated on page 215 of Duda 1973, clustering does not require the use of a distance metric. For example, a nonmetric similarity function s(x, x′) can be used to compare two vectors x and x′. Conventionally, s(x, x′) is a symmetric function whose value is large when x and x′ are somehow “similar”. An example of a nonmetric similarity function s(x, x′) is provided on page 216 of Duda 1973.

Once a method for measuring “similarity” or “dissimilarity” between points in a dataset has been selected, clustering requires a criterion function that measures the clustering quality of any partition of the data. Partitions of the data set that extremize the criterion function are used to cluster the data. See page 217 of Duda 1973. Criterion functions are discussed in Section 6.8 of Duda 1973. More recently, Duda et al., Pattern Classification, 2^{nd} edition, John Wiley & Sons, Inc. New York, has been published. Pages 537-563 describe clustering in detail. More information on clustering techniques can be found in Kaufman and Rousseeuw, 1990, Finding Groups in Data: An Introduction to Cluster Analysis, Wiley, New York, N.Y.; Everitt, 1993, Cluster analysis (3d ed.), Wiley, New York, N.Y.; and Backer, 1995, Computer-Assisted Reasoning in Cluster Analysis, Prentice Hall, Upper Saddle River, N.J. Particular exemplary clustering techniques that can be used in the present invention include, but are not limited to, hierarchical clustering (agglomerative clustering using nearest-neighbor algorithm, farthest-neighbor algorithm, the average linkage algorithm, the centroid algorithm, or the sum-of-squares algorithm), k—means clustering, fuzzy k—means clustering algorithm, and Jarvis-Patrick clustering.

5.6.3 Methods for Computing Similarity Metrics Data

Similarity metrics describe the relations between sharing preference profiles or content characteristics. The following provides nonlimiting examples of how such similarity metrics that can be computed.

Pearson Correlation: Pearson correlation measures the relative shape of the cellular constituent regulations rather than the absolute levels. This is a natural choice because it is widely used to measure cellular constituent correlations. Examples given in Section 6 illustrate the use of Pearson correlation in identifying the most conserved interactions between pair of cellular constituents across five datasets.

Euclidean Distance: Euclidean distance measures the absolute level of cellular constituent regulation, and would not be appropriate for this analysis. For example, two cellular constituents whose abundance levels are matched to one another across the database could still be far apart in Euclidean space if the absolute levels in each experiment are different. The Euclidean distance can also make cellular constituents that are uncorrelated appear close together; for example, if two cellular constituents had abundance levels close to zero across the database but were otherwise randomly correlated they could still appear close in Euclidean space.

Spearman Correlation: The Spearman correlation uses ranks rather than raw expression levels of the cellular constituents, which makes it less sensitive to extreme values in the data. It is possible that extreme values in the dataset will significantly influence the Pearson calculation and thereby enable a small number of microarray experiments to have a disproportionately large effect on our gene similarity measure. Spearman correlations between every pair of cellular constituents may be computed and compared with the results from Pearson correlation calculation. Spearman and Pearson correlation calculations provide convenient methods of cross-validation. However, it has been shown that Pearson correlation more accurately reflects the understand relations between cellular constituents than Spearman correlation does.

5.6.4 Exemplary Methods for Statistical Analysis

Statistical methods may also be used to describe the relations between sharing preference profiles or content characteristics, for example, through building a statistical model or function. The following provides nonlimiting examples of such statistical methods.

Principal component analysis (PCA). PCA is a technique for simplifying a dataset, by reducing multidimensional datasets to lower dimensions for analysis. For example, PCA can be used to reduce the complexity of a sharing preference profile in order to facility better and more efficient content characterization and comparison. PCA is a linear transformation that transforms the data to a new coordinate system such that the greatest variance by any projection of the data comes to lie on the first coordinate (called the first principal component), the second greatest variance on the second coordinate, and so on. PCA can be used for dimensionality reduction in a dataset while retaining those characteristics of the dataset that contribute most to its variance, by keeping lower-order principal components and ignoring higher-order ones. Such low-order components often contain the “most important” aspects of the data. But this is not necessarily the case, depending on the application. PCA has the distinction of being the optimal linear transformation for keeping the subspace that has largest variance. This advantage, however, comes at the price of greater computational requirement if compared, for example, to the discrete cosine transform. Unlike other linear transforms, the PCA does not have a fixed set of basis vectors. Its basis vectors depend on the data set. See Duda et al., 2001, Pattern Classification, second edition, John Wiley & Sons, Section 10.13.1, which is hereby incorporated by reference herein in its entirety.

Independent component analysis (ICA). ICA is a computational method for separating a multivariate signal into additive subcomponents supposing the mutual statistical independence of the non-Gaussian source signals. It is a special case of blind source separation. For example, ICA may used to separate and characterize complex web browsing activities such that a sharing preference profile may be established as a composite of these separated studies, thereby enhancing accuracy of such characterization. Content characteristics may also be analyzed similarly using this type of analysis. ICA can be divided into noiseless and noisy cases, where noiseless ICA is a special case of noisy ICA. The statistical method finds the independent components (for example, factors, latent variables or sources) by maximizing the statistical independence of the estimated components. Non-Gaussianity, motivated by the central limit theorem, is one method for measuring the independence of the components. Non-Gaussianity can be measured, for instance, by kurtosis or approximations of negentropy. Mutual information is another popular criterion for measuring statistical independence of signals. Typical algorithms for ICA use centering, whitening and dimensionality reduction as preprocessing steps in order to simplify and reduce the complexity of the problem for the actual iterative algorithm. Whitening and dimension reduction can be achieved with principal component analysis or singular value decomposition. Whitening ensures that all dimensions are treated equally a priori before the algorithm is run. Algorithms for ICA include infomax, FastICA and JADE, but there are many others also. See Hyvarinen et al., Independent Component Analysis, 2001, John Wiley & Sons, which is hereby incorporated herein by reference.

Canonical correlation analysis (CCA). In statistics, CCA is a way of making sense of cross-covariance matrices. CCA is an additional procedure for assessing the relationship between variables (e.g., content characteristics or sharing preference profiles). Specifically, this analysis allows investigation of the relationship between two sets of variables. For example, the relationship between content a and content c as well as the relationship between content b and content c (as discussed hereinabove in Section) may also be analyzed using CCA. Some of the computational methods used in canonical correlation analysis include eigenvalues, square root of the eigenvalues, canonical weights and canonical Scores

Detailed discussion on PCA, ICA and CCA, may be found in Jolliffe, 2002, Principal Component Analysis, Springer; second edition, New York; Hyvarinen, et al., 2001 Independent Component Analysis, John Wiley & Sons, New York; Duda et al., 2001, Pattern Classification, 570-573, second edition, John Wiley & Sons, New York; Thompson, 1984, Canonical Correlation Analysis: Uses and Interpretation, Sage Publications, Inc.; and Cohen and Cohen, 1984, Applied Multiple Regression/Correlation Analysis for the Behavioral Sciences, second edition, Lawrence Erlbaum Associates; each of which is hereby incorporated by reference herein in its entirety.

### 5.7. Computer System and Program Product

The present invention can be implemented as a computer system and/or a computer program product that comprises a computer program mechanism embedded in a computer readable storage medium. Further, any of the methods of the present invention can be implemented in one or more computers or computer systems. Further still, any of the methods of the present invention can be implemented in one or more computer program products. Some embodiments of the present invention provide a computer system or a computer program product that encodes or has instructions for performing any or all of the methods disclosed herein. Such methods/instructions can be stored on a CD-ROM, DVD, magnetic disk storage product, or any other computer readable data or program storage product. Such methods can also be embedded in permanent storage, such as ROM, one or more programmable chips, or one or more application specific integrated circuits (ASICs). Such permanent storage can be localized in a server, 802.11 access point, 802.11 wireless bridge/station, repeater, router, mobile phone, or other electronic devices. Such methods encoded in the computer program product can also be distributed electronically, via the Internet or otherwise, by transmission of a computer data signal (in which the software modules are embedded) either digitally or on a carrier wave.

Some embodiments of the present invention provide a computer system or a computer program product that contains any or all of the program modules as disclosed herein. These program modules can be stored on a CD-ROM, DVD, magnetic disk storage product, or any other computer readable data or program storage product. The program modules can also be embedded in permanent storage, such as ROM, one or more programmable chips, or one or more application specific integrated circuits (ASICs). Such permanent storage can be localized in a server, 802.11 access point, 802.11 wireless bridge/station, repeater, router, mobile phone, or other electronic devices. The software modules in the computer program product can also be distributed electronically, via the Internet or otherwise, by transmission of a computer data signal (in which the software modules are embedded) either digitally or on a carrier wave.

### 6. Examples

The following are exemplary methods for implementing the invention disclosed in the current application. The examples are provided by way of illustration and should not in any way limit the scope of the current invention.

6.1 Exemplary Embodiments for Creating and Managing Share Objects

Exemplary methods for creating and managing share objects are disclosed. In the examples provided, a java-based application, termed ShareThis, serves to illustrate the implementation of a host application in accordance with the current invention.

6.1.1 Creating a Share Object

In one embodiment, a ShareThis object is created by calling a SHARETHIS.addEntry(propertyList,flags) function. The first argument is a javascript property list containing the attributes of the shared object. This is the information that will be sent to people in a share event. See Section 6.1.2. for an exemplary list of user assignable properties. The second argument is a javascript property list that contains control directives for the application program interface. Currently, the only supported property is showButton which instructs the script to, or not to, display the button. If no flags are passed, showButton will default to “true.”

In one embodiment, a web publisher or website owner chooses to display a ShareThis button on their websites using, for example, some routine modification of the following Java code:

<script language=“javascript” type=“text/javascript”>
SHARETHIS.addEntry({
title:‘Share me’,
summary:‘Sharing is good for the soul.’,
icon: ‘http://path.to/icon’
}, {button:true} );
</script>

It is to be noted that the number of script blocks is not limited so a web publisher or website owner may have as many script blocks as possible. This unlimited feature is particularly suitable for a constantly changing web site such as a blog archive page or hit lists.

### 6.2. Object Properties

Shared objects as defined in the ShareThis application closely follow the structure of the entry element as specified by the hAtom microformat. hAtom is a microformat for content that can be syndicated, primarily but not exclusively for web blog postings. hAtom is based on a subset of the Atom syndication format (see http://www.atomenabled.org/). hAtom is one of several microformats open standards. More information may be found at http://microformats.org/wiki/hatom. Shared objects, like feeds, are often viewed without the context of a web page, so a web site user has to be descriptive. Since the encoding of a web page is often unknown, ShareThis requires that that all strings be encoded in utf-8. In some embodiments of the present invention, the content attribute is embedded in share messages where possible (e.g., email, web page, etc.).

The following is an exemplary list of user assignable properties for a shared object:

title: utf-8 string, defaults to document.title

url: fully qualified URL, defaults to document.URL

summary: utf-8 string, defaults to null

content: utf-8 string, defaults to null

icon: fully qualified URL, defaults to Alexa thumbnail of url

updated: ISO 8601 date, defaults to document.lastModified

published: ISO 8601 date, defaults to null

author: utf-8 string, defaults to null

category: utf-8 string, defaults to null

### 6.3. JavaScript Elements

In some embodiments, JavaScript array elements are used to provide greater control over the behavior over buttons and/or widget on a web page. The elements are placed in brackets immediately after the object definition. See, for example, the ShareThis button example in the sample code above. The following are exemplary ShareThis JavaScript elements in some embodiments of the present invention:
button: create a customized ShareThis button and/or label for any object or page to be shared
popup: launches the widget in a new window rather than an iFrame
embeds: allows embedded elements to be seen while iFrame is loading
onclick: allows for execution of a custom function when button is clicked

6.4. Alternative Embodiments

6.4.1. Member Registration and Sharing Preference Profile Update

The present invention also provides systems and methods for sharing content within a meta-community, where each member of the meta-community has stored on a remote data server (i) one or more network identifiers and (ii) a contact list comprising a plurality of network identifiers, each network identifier in the plurality of network identifiers identifying a member in a plurality of members in the meta-community. In general, a membership to the meta-community is done through a method for creating a member sharing preference profile on a remote data server. Specifically, the method comprises submitting, to the remote data server, a plurality of sharing records, where each sharing record in the plurality of sharing records corresponds to a sharing event in which a first member in the meta-community sends or receives content via a sharing interface through a host application on a client device associated with the first member and through the client device the host application is connected to a network. In the method, there is created, on the remote data server, a sharing preference profile for the first member based on the plurality of sharing records. Each record in the plurality of sharing records comprises: (1) an identification for at least a portion of the content, (2) a network identifier that specifies at least one recipient for the portion of the content, and (3) at least one network identifier for the first member. The sharing preference profile comprises a plurality of categories of interests that are associated with the first member. The sharing preference profile is updated each time a new sharing event takes place in which the first member sends or receives content from a member of the meta-community or an un-registered user of the meta-community.

6.4.2. Sharing Preference Profile Update

Once created, a sharing preference profile does not remain static. It can be modified and updated as the owner of the sharing preference profile sends or receives content from other members of the meta-community or un-registered user of the meta-community. In some embodiments, the method further comprises modifying the sharing preference profile of the first member based on an interest provided by the first member. In some embodiments, the sharing interface comprises means for inputting a network identifier of the first member and means for associating the network identifier with content shared by the first member. In some embodiments, the content sent or received by the first member comprises a text message, a uniform resource location, a web link, an electronic message, a file, an image, an audio file, a video file, or a media file. In some embodiments, the client device is selected from the group consisting of a desktop computer, a laptop computer, a cellular phone, a personal digital assistant (PDA), a mobile device equipped with a network device, a pager, a television, a media player, a digital video recorder (DVR), and a networked device.

In some embodiments, the methods further comprise one or more of the following: submitting, to the remote data server, a new sharing record associated with the first member; updating the sharing preference profile of the first member based on the new sharing record; storing, as a collected record for the first member, the first plurality of sharing records associated with the first member; and modifying the sharing preference profile of the first member based on an interest provided by the first member.

6.4.3. Recipient Recommendation

The present invention also provides a method for sharing content within a meta-community. Each member of the meta-community has stored on a remote data server (i) one or more network identifiers, (ii) a sharing preference profile and (iii) a contact list comprising a plurality of network identifiers, each network identifier in the plurality of network identifiers identifying a member in a plurality of members in the meta-community. The method comprises receiving, from a first member of the meta-community, a first identification of content to be shared with one or more other members of the meta-community through a host application on a client device associated with the first member through which the host application is connected to a network. The method further comprises determining a plurality of suggested recipients from the contact list of the first member by searching a database of sharing preference profiles of members of the meta-community based on a comparison of (1) at least one characteristic of the content identified by the first identification and (2) at least one characteristic from each sharing preference profile of each members of the meta-community, where the database comprises sharing preference profiles of all members of the meta-community and is addressable by the remote data server. The method further comprises transmitting a network identifier for each suggested recipient in the plurality suggested recipients to the first member via the host application. Then, from the first member of the meta-community, one or more actual recipients from the plurality of suggested recipients are received. The method further comprises accepting, at the remote data server after the content identified by the first identification has been shared between the first member and the one or more actual recipients, a new sharing record associated with the content identified by the first identification. The new sharing record comprises the first identification and network identifiers for the one or more actual recipients.

In some embodiments, the method further comprises updating the sharing preference profile of the first member based on the new sharing record. In some embodiments, the method further comprises creating the sharing preference profile of the first member based on a list of interests provided by the first member prior to the receiving step.

6.4.4. Content Recommendation

The present invention also provides a method for sharing content within a meta-community. Each member of the meta-community has stored on a remote data server (i) one or more network identifiers and (ii) a contact list comprising a plurality of network identifiers, where each network identifier in the plurality of network identifies a member in a plurality of members in the meta-community. Specifically, the method comprises receiving, at the remote data server, a plurality of sharing records. Each sharing record in the plurality of sharing records corresponding to a sharing event in which a first member in the meta-community sends or receives content via a sharing interface through a host application on a client device associated with the first member and through the client device the host application is connected to a network. Each sharing record in the plurality of sharing records comprises (1) an identification for a portion of the shared content, (2) a network identifier that specifies at least one recipient for the portion of the shared content, and (3) a network identifier for the first member. The method also comprises creating, on the remote data server, a sharing preference profile for the first member of the meta-community based on the plurality of sharing records. The sharing preference profile comprises a plurality of categories of interest that are associated with the first member and the sharing preference profile is updated each time a new sharing event takes place in which the first member sends or receives content to a member of the meta-community or an un-registered user of the meta-community. In some embodiments, the method further comprises creating modifying the sharing preference profile of the first member based on an interest provided by the first member. In some embodiments, the sharing interface comprises means for inputting a network identifier of the first member and means for associating the network identifier with content that is shared by the first member. In some embodiments, the method further comprises receiving, from the first member of the meta-community, a first identification of content to be shared with one or more other members of the meta-community through the host application; and determining, a plurality of suggested recipients from the contact list of the first member by comparing (a) one or more characteristics in sharing preference profiles in a database of sharing preference profiles and (b) one or more characteristics of the content identified by the first identification, where the database comprises of sharing preference profiles contains the sharing preference profile of each member of the meta-community and is addressable by the remote data server. In some embodiments a plurality of network identifiers corresponding to a plurality suggested recipients is transmitted to the first member via the host application on the client device through which the host application is connected to the network and, at the remote data server, an indication of one or more actual recipients in the plurality of suggested recipients is received. In such embodiments, the method further comprises accepting, at the remote data server after the content identified by the first identification has been shared between the first member and the one or more actual recipients, a new sharing record associated with the first identification. The new sharing record comprises the first identification and a network identifier for each of the one or more actual recipients. In some embodiments, the method further comprises updating the sharing preference profile of the first member based on the new sharing record. In some embodiments, the plurality of the plurality of sharing records associated with the first member is stored on the remote data server as one or more collected records.

6.4.5. Identifying Relevant Content or Recipients

The present invention also provides a method for sharing content within a meta-community, where each member of the meta-community has stored on a remote data server (i) one or more network identifiers, (ii) a sharing preference profile, and (iii) a contact list comprising a plurality of network identifiers, each network identifier in the plurality of network identifiers identifying a member in the meta-community. The method comprises receiving, from a first member of the meta-community, a first identification of content to be shared through a host application on a client device associated with the first member through which the host application is connected to a network and then proposing, from a sharing interface via the host application, a second identification of suggested share content, where the second identification of suggested share content is determined, without user intervention, based on a comparison of (1) one or more characteristics of content shared between members of the meta-community or between members and un-registered users of the meta-community and (2) one or more characteristics of the content identified by the first identification, and where the identification is performed by searching a database addressable by the remote data server that contains content previously shared between members of the meta-community or between members and un-registered users of the meta-community. Then, from the first member, all or a portion of the suggested share content is accepted as actual additional share content and (a) the first identification or the content identified by the first identification of content and (b) the actual additional share content or a second identification corresponding to the actual additional share content is transmitted via the network through the sharing interface to one or more members of meta-community or one or more unregistered users specified by the first member.

In some embodiments, the suggested share content comprises content that was previously shared between members of the meta-community or between members and un-registered users of the meta-community. In some embodiments, the suggested share content comprises an advertisement that is relevant to the content identified by the first identification.

In other embodiments, the list of suggested recipients is identified by comparing sharing preference profiles of members or unregistered users of the meta-communities. For example, one or more characteristics of the sharing preference profiles will be used to search against one or more database of sharing preference profiles. Members with similar sharing preference profiles will be identified. In some embodiments, members with similar sharing preference profiles that are also in the contact list of the first member will be recommended to the first member as suggested recipients of the content identified by the first member. In some embodiments, the first member may choose to expand the scope of suggested recipients to include additional members who have subscribed to receive a certain type of content.

### 7. REFERENCES CITED

All references cited herein are incorporated herein by reference in their entirety and for all purposes to the same extent as if each individual publication or patent or patent application was specifically and individually indicated to be incorporated by reference in its entirety for all purposes.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

We claim:

1. A method for sharing content within a meta-community comprising a plurality of members, said method comprising:
(A) receiving, from a first member in said plurality of members, an identification of first content to be shared through a host application on a client device through which said host application is connected to a network, wherein each member in said plurality of members has stored on one or more remote data servers: (i) one or more network identifiers, (ii) a sharing preference profile, and (iii) a contact list comprising a plurality of network identifiers, each network identifier in the plurality of network identifiers identifying a member in the plurality of members;
(B) proposing, from a sharing interface via said host application, responsive to said receiving step, a plurality of suggested recipients within a contact list of said first member that are identified, without user intervention, based on a comparison of (1) the sharing preference profiles of members of said meta-community that are addressable by said one or more remote data servers and (2) at least one characteristic of said first content, each respective suggested recipient in said plurality of suggested recipients associated with a corresponding network identifier a plurality of network identifiers;
(C) accepting, from said first member, a selection of one or more actual recipients from said plurality of suggested recipients; and
(D) transmitting said first content via a network to said one or more actual recipients via said sharing interface.

2. The method of claim 1, wherein a sharing preference profile of a respective member in the plurality of members is created based at least one interest provided by said respective member.

3. The method of claim 1, wherein each respective suggested recipient in the plurality of suggested recipients of said proposing step (B) is identified by a network identifier associated with the respective suggested recipient.

4. The method of claim 1, wherein said sharing interface comprises means for inputting a network identifier of said first member.

5. The method of claim 1, wherein each respective suggested recipient in said plurality of suggested recipients is communicated in said proposing step to said first member as an email address, a telephone number, a messenger identification, a unique uniform resource location, or an online alias that uniquely corresponds to the respective suggested recipient.

6. The method of claim 1, wherein said contact list for said first member is automatically obtained from an electronic address book associated with said first member without user intervention from said first member at a time before said receiving step (A).

7. The method of claim 6, wherein said electronic address book is an online email address book, an online chat address book, an online messenger address book, an email program address book, or an operating system address book.

8. The method of claim 1, wherein said first content is a text message, a uniform resource location, a web link, an electronic message, a file, an image, an audio file, a video file, or a media file.

9. The method of claim 1, wherein said client device is selected from the group consisting of a desktop computer, a laptop computer, a cellular phone, a personal digital assistant (PDA), a mobile device equipped with a network device, a pager, a television, a media player, a digital video recorder (DVR), and a networked device.

10. A method for sharing content within a meta-community, said method comprising:
(A) submitting, to one or more remote data servers, a plurality of sharing records, each sharing record in the plurality of sharing records for a sharing process in a corresponding plurality of sharing processes, each sharing process in the plurality of sharing processes describing an event in which a first member in said meta-community sends or receives content via a sharing interface through a host application on a client device associated with said first member through which said host application is connected to a network, wherein each record in said plurality of sharing records comprises (i) an identifier for at least a portion of the content and a network identifier that specifies at least one recipient for said portion of said content, and wherein each member of said meta-community has stored on said one or more remote data servers: (i) one or more network identifiers and (ii) a contact list comprising a plurality of network identifiers, each network identifier in the plurality of network identifiers identifying a member in a plurality of members in said meta-community; and
(B) creating, on said remote data server, a sharing preference profile for said first member based on each sharing record associated with said first member, wherein said sharing preference profile comprises a plurality of categories of interest that are associated with said first member, and wherein said sharing preference profile is updated each time a new sharing event takes place in which said first member sends to or receives content from a member of said plurality of members in said meta-community or an un-registered user of said meta-community.

11. The method of claim 10, the method further comprising modifying the sharing preference profile of the first member based on an interest provided by said first member.

12. The method of claim 10, wherein said sharing interface comprises:
means for inputting a network identifier of the first member; and
means for associating the network identifier with content shared by the first member.

13. The method claim 10, wherein said content sent or received by the first member comprises a text message, a uniform resource location, a web link, an electronic message, a file, an image, an audio file, a video file, or a media file.

14. The method of claim 10, wherein said client device is selected from the group consisting of a desktop computer, a laptop computer, a cellular phone, a personal digital assistant (PDA), a mobile device equipped with a network device, a pager, a television, a media player, a digital video recorder (DVR), and a networked device.

15. The method of claim 10, the method further comprising:
(C) receiving, from said first member of said meta-community, a first identification of content to be shared through said host application;
(D) proposing, from a sharing interface via said host application, a plurality of suggested recipients, wherein said plurality of suggested recipients are identified, without user intervention, based on a comparison of (a) the sharing preference profile of members of said meta-community in said one or more remote data servers and (b) at least one characteristic of the content identified by said first identification, wherein each suggested recipient in said plurality of suggested recipients is identified by a unique network identifier;
(E) accepting, from said first member, a selection of one or more actual recipients from said plurality of suggested recipients; and
(F) transmitting the content identified by said first identification of content via said network to said one or more actual recipients via said sharing interface.

16. The method of claim 15, further comprising submitting a new sharing record associated with said first member to said one or more remote data servers.

17. The method of claim 16, further comprising updating said sharing preference profile of said first member based on said new sharing record in which the first member sent or received content to another member of said meta-community.

18. The method of claim 15, the method further comprising storing, as a collected record for said first member, at least a portion of the sharing records associated with said first member.

19. The method of claim 15, the method further comprising modifying the sharing preference profile of the first member based on an interest provided by said first member.

20. A method for sharing content within a meta-community comprising a plurality of members, said method comprising:
(A) receiving, from a first member of said meta-community, a first identification of content to be shared with one or more other members of said meta-community through a host application on a client device associated with the first member through which said host application is connected to a network, wherein each member in said plurality of members has stored on one or more remote data servers: (i) one or more network identifiers, (ii) a sharing preference profile and (iii) a contact list comprising a plurality of network identifiers, each network identifier in the plurality of network identifiers identifying a member in a plurality of members in said meta-community;
(B) determining a plurality of suggested recipients by comparing at least one characteristic in the respective preference profile of each member of the plurality of members to at least one characteristic of the content identified by the first identification of content;
(C) transmitting a network identifier for each suggested recipient in said plurality suggested recipients to said first member via said host application;
(D) receiving, from said first member of said meta-community, one or more actual recipients from said plurality of suggested recipients; and
(E) accepting, at said one or more remote data servers, after said content identified by said first identification has been shared between said first member and said one or more actual recipients, a new sharing record associated with said content identified by said first identification, wherein said new sharing record comprises said first identification and network identifiers for said one or more actual recipients.

21. The method of claim 20, the method further comprising updating said sharing preference profile of said first member based on said new sharing record.

22. The method of claim 20, the method further comprising creating the sharing preference profile of the first member based on a list of interests provided by said first member prior to said receiving step (A).

23. The method claim 20, wherein the content identified by said first identification comprises a text message, a uniform resource location, a web link, an electronic message, a file, an image, an audio file, a video file, or a media file.

24. The method of claim 20, wherein said client device is selected from the group consisting of a desktop computer, a laptop computer, a cellular phone, a personal digital assistant (PDA), a mobile device equipped with a network device, a pager, a television, a media player, a digital video recorder (DVR), and a networked device.

25. A method for sharing content within a meta-community comprising a plurality of members, said method comprising:
(A) receiving, at one or more remote data servers, a plurality of sharing records each sharing record in the plurality of sharing records for a sharing event in which a first member in said meta-community sends or receives content via a sharing interface through a host application on a client device associated with the first member through which said host application is connected to a network, wherein
each sharing record in the plurality of sharing records comprises (1) an identification for at least a portion of the shared content, (2) a network identifier that specifies at least one recipient for said portion of the shared content, and (3) a network identifier for said first member, and
each member of said meta-community has stored on said one or more remote data servers: (i) one or more network identifiers and (ii) a contact list comprising a plurality of network identifiers, each network identifier in the plurality of network identifying a member in a plurality of members in said meta-community; and
(B) creating, on said one or more remote data servers, a sharing preference profile for said first member of said meta-community based on each sharing record in the plurality of sharing records, wherein said sharing preference profile comprises a plurality of categories of interest that are associated with said first member, and wherein said sharing preference profile is updated each time a new sharing event takes place in which said first member sends or receives content to a member of said plurality of members in said meta-community or an un-registered user of said meta-community.

26. The method of claim 25, the method comprising creating the sharing preference profile of the first member based on an interest provided by said first member prior to said receiving step (A).

27. The method of claim 25, wherein said sharing interface comprises
means for inputting a network identifier of the first member; and
means for associating the network identifier with content that is shared by the first member.

28. The method of claim 25, wherein said content sent or received by the first member comprises a text message, a uniform resource location, a web link, an electronic message, a file, an image, an audio file, a video file, or a media file.

29. The method of claim 25, wherein said client device associated with the first member is selected from the group consisting of a desktop computer, a laptop computer, a cellular phone, a personal digital assistant (PDA), a mobile device equipped with a network device, a pager, a television, a media player, a digital video recorder (DVR), and a networked device.

30. The method of claim 25, the method further comprising:
(C) receiving, from the first member, a first identification of content to be shared with one or more other members of said meta-community through said host application;
(D) determining a plurality of suggested recipients from the contact list of said first member by comparing (a) one or more characteristics in sharing preference profiles of members of said meta-community and (b) one or more characteristics of the content identified by said first identification;
(E) transmitting a plurality of network identifiers corresponding to a plurality suggested recipients to said first member via said host application on said client device through which said host application is connected to said network;
(F) receiving, at said one or more remote data servers, an indication of one or more actual recipients in said plurality of suggested recipients; and
(G) accepting, at said one or more remote data servers after the content identified by said first identification has been shared between said first member and the one or more actual recipients, a new sharing record associated with the first identification, wherein said new sharing record comprises said first identification and a network identifier for each of said one or more actual recipients.

31. The method of claim 30, the method further comprising:
(H) updating the sharing preference profile of said first member based on said new sharing record.

32. The method of claim 30, wherein one or more of the plurality of sharing records associated with said first member are stored on a remote data server in said one or more remote data servers.

33. A method for sharing content within a meta-community, said method comprising:
(A) receiving, from a first member of said meta-community, a first identification of content to be shared through a host application on a client device associated with the first member through which said host application is connected to a network, wherein each member of said meta-community has stored on one or more remote data servers: (i) one or more network identifiers, (ii) a sharing preference profile, and (iii) a contact list comprising a plurality of network identifiers, each network identifier in the plurality of network identifiers identifying a member in said meta-community;
(B) proposing, from a sharing interface via said host application, a second identification of suggested share content, wherein said second identification of suggested share content is determined, without user intervention, based on a comparison of (1) one or more characteristics of content shared between members of said meta-community or between members and un-registered users of said meta-community and (2) one or more characteristics of the content identified by said first identification, and wherein said identification is performed by searching content previously shared between members of said meta-community or between a member and an un-registered user of said meta-community;
(C) accepting, from said first member, all or a portion of the suggested share content as actual additional share content; and
(D) transmitting (a) the first identification or the content identified by the first identification of content and (b) said actual additional share content or a second identification corresponding to said actual additional share content via the network through said sharing interface to one or more members of said meta-community or one or more unregistered users specified by the first member.

34. The method of claim 33, wherein said suggested share content comprises content that was previously shared between members of said meta-community or between members and un-registered users of said meta-community.

35. The method of claim 33, wherein said suggested share content comprises an advertisement that is relevant to the content identified by said first identification.

36. The method of claim 33, wherein said first identification of content refers to a text message, a uniform resource location, a web link, an electronic message, a file, an image, an audio file, a video file, or a media file.

37. The method of claim 33, wherein said client device is selected from the group consisting of a desktop computer, a laptop computer, a cellular phone, a personal digital assistant (PDA), a mobile device equipped with a network device, a pager, a television, a media player, a digital video recorder (DVR), and a networked device.

38. A method for sharing content within a meta-community, said method comprising:
(A) submitting, from a first member of said meta-community to a remote data server, a first identification of content to be shared through a host application on a client device associated with said first member through which said host application is connected to a network, wherein each member of said meta-community has stored on one or more remote data servers: (i) one or more network identifiers, (ii) a sharing preference profile, and (iii) a contact list comprising a plurality of network identifiers, each network identifier in the plurality of network identifiers identifying a member in said meta-community;
(B) proposing, from a sharing interface via said host application, a second identification of suggested share content, wherein said second identification of suggested share content is determined, without user intervention, based on a comparison of (1) one or more characteristics of content shared between members of said meta-community or between members and un-registered users of said meta-community and (2) one or more characteristics of the content identified by said first identification, and wherein said identification is performed by searching content previously shared between members of said meta-community or between members and un-registered users of said meta-community;
(C) accepting, by said first member, all or a portion of the suggested share content as actual additional share content; and
(D) transmitting (a) the first identification or the content identified by the first identification of content and (b) said actual additional share content or a second identification corresponding to said actual additional share content via the network through said sharing interface to one or more members of said meta-community or one or more unregistered users specified by the first member.

39. A computer system comprising
a processor, and
a memory coupled to said processor and encoding one or more programs, wherein said one or more programs cause the processor to carry out the method of any one of claims 1, 10, 20, 25, 33, and 38.

40. A computer program product for use in conjunction with a computer having a processor and a memory connected to the processor, said computer program product comprising a computer readable storage medium having a computer program mechanism encoded thereon, wherein said computer program mechanism may be loaded into the memory of said computer and cause said computer to carry out the method of any one of claims 1, 10, 20, 25, 33, and 38.
